(19) United States
(12) Patent Application Publication
(10) Pub. No.: US 2026/0122294 A1
(43) Pub. Date: Apr. 30, 2026

(54) ANNOTATION METADATA SYSTEM FOR ASSET INTERCHANGE

(71) Applicant: TENCENT AMERICA LLC, Palo Alto, CA (US)

(72) Inventors: Arianne HINDS, Los Gatos, CA (US); Stephan WENGER, Hillsborough, CA (US)

(73) Assignee: TENCENT AMERICA LLC, Palo Alto, CA (US)

(21) Appl. No.: 19/323,035

(22) Filed: Sep. 9, 2025

Related U.S. Application Data
(60) Provisional application No. 63/713,979, filed on Oct. 30, 2024.
(60) Provisional application No. 63/713,964, filed on Oct. 30, 2024.

(51) Int. Cl. H04N 21/234; H04N 21/44; H04N 21/81; H04N 21/84; H04N 21/854; H04N 21/8543

(52) U.S. Cl. CPC H04N 21/23412; H04N 21/44012; H04N 21/8146; H04N 21/84; H04N 21/85406; H04N 21/8543

(57) ABSTRACT

There is provided a method of streaming immersive media, executable by a processor, the method including: ingesting media content of the immersive media and including Independent Mapping Space (IMS) metadata of a scene of the media content; extending the IMS metadata by annotating the IMS metadata with Immersive Technologies Media Format (ITMF) metadata representing at least an ITMF node code point; and streaming the media content of the immersive media based on extending the IMS metadata annotated with the ITMF metadata.

### CROSS REFERENCE TO RELATED APPLICATIONS

This application claims priority to provisional U.S. 63/713,964, filed Oct. 30, 2024, and to provisional U.S. 63/713,979, filed on Oct. 30, 2024, the contents of which are hereby expressly incorporated by reference, in their entireties, into the present application.

### BACKGROUND

### 1. Field

The present disclosure describes embodiments generally related to architectures, structures and components for systems and networks that distribute media, including video, audio, geometric (3D) objects, haptics, associated metadata, or other content for a client device. Particular embodiments are directed systems, structures, and architectures for distribution of media content to heterogenous immersive and interactive client devices.

### 2. Description of Related Art

Video encoding and/or decoding using inter-picture prediction with motion compensation has been known for decades. Uncompressed digital video can consist of a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed video has significant bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GByte of storage space. “Immersive Media” generally refers to media that stimulates any or all human sensory systems (visual, auditory, somatosensory, olfactory, and possibly gustatory) to create or enhance the perception of the user being physically present in the experience of the media, i.e., beyond what is distributed over existing (e.g., “legacy”) commercial networks for timed two-dimensional (2D) video and corresponding audio; such timed media also being known as “legacy media”. Another definition for “immersive media” is media that attempt to create, or imitate the physical world through digital simulation of kinetics and laws of physics, thereby stimulating any or all human sensory systems so as to create the perception by the user of being physically present inside a scene that depicts a real or virtual world.

Immersive media-capable presentation devices may refer to devices equipped with sufficient resources and capabilities to access, interpret, and present immersive media. Such devices are heterogeneous in terms of the quantities and formats of the media that they may support in terms of media provided by a network. Likewise, media are heterogenous in terms of the amount and types of network resources required to distribute such media at scale. “At scale” may refer to the distribution of media by service providers that achieve distribution equivalent to that of legacy video and audio media over networks, e.g., Netflix, Hulu, Comcast subscriptions, and Spectrum subscriptions. In contrast, legacy presentation devices such as laptop displays, televisions, and mobile handset displays are homogenous in their capabilities because these devices are currently comprised of rectangular display screens that consume frame-based 2D rectangular video or still images as their primary visual media formats. Some of the frame-based visual media formats commonly used in legacy presentation devices may include High Efficiency Video Coding/H.265, Advanced Video Coding/H.264, and Versatile Video Coding/H.266, for video media. The term “frame-based” media refers to the characteristic that the visual media are comprised of one or more consecutive rectangular frames of imagery. In contrast, “scene-based” media refers to media that are organized by “scenes” in which each scene refers to individual assets that collectively describe an, often visual, scene. Note that scene-based media may also be comprised of other media that is not visual, e.g., haptics, and olfactory media. A comparative example between frame-based and scene-based visual media is illustrated in the case of visual media illustrating a forest. In the frame-based representation, the forest is captured using camera devices such as those provided on mobile phones. The user enables the camera to focus on the forest and the frame-based media that is captured by the phone is the same as what the user sees through the camera viewport provided on the phone, including any movement of the camera initiated by the user. The resulting frame-based representation of the forest is the series of 2D images that are recorded by the camera usually at a standard rate of 30 frames-per-second or 60 frames-per-second. Each image is a collection of pixels where the information stored in each pixel is congruent, one pixel to the next.

In contrast, a scene-based representation of a forest is comprised of individual assets that describe each of the objects in the forest, and an often human-readable scene graph description that presents a myriad of metadata that describe the assets or how the assets are to be rendered. For example, the scene-based representation may include individual objects called “trees” where each tree is comprised of a collection of smaller assets called “trunks,” “branches,” and “leaves.” Each tree trunk may be further described individually by a mesh that describes the full 3D geometry of the trunk and a texture that is applied to the tree-trunk mesh to capture the color and radiance properties of the trunk. Furthermore, the trunk may be accompanied by additional information that describes the surface of the trunk in terms of its smoothness or roughness or ability to reflect light. The corresponding human-readable scene graph description may provide information as to where to place the tree trunks relative to the viewport of a virtual camera that is focused into the forest scene. Furthermore the human-readable description may include information as to how many branches to generate and where to place them into the scene from the single branch asset called “branch.” Likewise the description may include how many leaves to generate and the position of the leaves relative to the branches and the tree trunks. Moreover, a transformation matrix may provide information as to how to scale or rotate the leaves so that the leaves do not appear homogenous. Overall, the individual assets that comprise the scene vary in terms of the type and quantities of information that is stored in each asset. Each asset is usually stored in its own file, but often the assets are used to create multiple instances of the objects that they are designed to create, e.g., the branches and leaves for each tree.

Those skilled in the art may appreciate that the human-readable portion of a scene graph is rich in metadata to not only describe logical relationships of assets to their position within the scene, but also instructions how to render the object, e.g., with various types of light sources, or with surface properties (to indicate the object has a metallic vs. matte surface) or other materials (porous or smooth texture). Other information often stored in the human readable portion of the graph is the relationship of assets with other assets, e.g., to form groups of assets that are rendered or handled as a single entity, e.g., the tree trunks with branches and leaves. Still other information that may be stored with the scene-based media include instructions how to access the media in terms of its physical storage, e.g., a parser of the media may need explicit information for how to locate or access the media, or in some cases, how to decrypt the media.

Examples of scene graphs with human readable components include glTF 2.0 where the node-tree component is provided in Java Script Object Notation (JSON) which is a human-readable notation to describe objects. Another example of a scene graph with a human readable component is the Immersive Technologies Media Format (ITMF most recent version is version 2.0) in which the OCS file is generated using XML, another human-readable notation format. The ITMF is currently specified in a suite of specifications comprised of three specifications including: the ITMF Scene Graph, ITMF Container, and ITMF Data Encoding specifications. The ITMF Scene Graph Specification specifies the scene graph description format which is stored in an “OCS” file, and its corresponding nodes, pins (e.g., input and output parameters for nodes), and attributes (characteristics of nodes that are generally immutable). The ITMF Container Specification specifies the binary representations, encryption mechanisms, and organization design used to package the scene graph OCS file and the corresponding assets for the scene. The ITMF Data Encoding Specification provides the numerical identifiers, i.e., code points, used to organize the types of nodes, pins, attributes, and other relevant information describing the structure of the scene. Another difference between scene-based and frame-based media is that in frame-based media the view that is created for the scene is identical to the view that the user captured via the camera, i.e., at the time that the media was created. When the frame-based media is presented by a client, the view of the media that is presented is the same as the view that is captured in the media, e.g., by the camera that was used to record the video. Sometimes, a small number of multiple views of the same scene (e.g., stereoscopic video) may be captured with a corresponding small number of multiple cameras, and delivered to a client (e.g., a VR head mounted display e.g., Oculus Quest) capable of presenting each of the multiple views. But the presentation of these multiple views may not afford the end user of the client display to experience an unlimited number of views, such may be the case of scene-based media.

With scene-based media, however, there may be a significantly larger number of views that the user can view the scene using a variety of virtual camera, e.g., a thin-lens camera vs. a panoramic camera. That is, a “virtual camera” can be described or supported by a render that allows the user to control which portions of the scene the user may experience. The distribution of any media over networks may employ media delivery systems and architectures that reformat the media from an input or network “ingest” media format to a distribution media format where that distribution media format is not only suitable to be ingested by the targeted client device and its applications, but is also conducive to being “streamed” over the network. Thus there may be two processes that are performed upon the ingested media by the network: 1) converting the media from a format A into a format B that is suitable to be ingested by the target client, i.e., based upon the client's capabilities to ingest certain media formats, and 2) preparing the media to be streamed. “Streaming” of media broadly refers to the fragmenting and or packetizing of the media so that it can be delivered over the network in consecutive smaller-sized “chunks” logically organized and sequenced according to either or both the media's temporal or spatial structure. “Transforming,” which is sometimes referred to as “transcoding,” of media from a format A to a format B may be a process that is performed, usually by the network or by the service provider, prior to distributing the media to the client. Such transcoding may be comprised of converting the media from a format A to a format B based upon prior knowledge that format B is somehow a preferred format, or the only format, that can be ingested by the target client, or is better suited for distribution over a constrained resource such as a commercial network. In many cases, but not all, both steps of transforming the media and preparing the media to be streamed are necessary before the media can be received and processed by the client from the network. The above one or two-step processes acted upon the ingested media by the network, i.e., prior to distributing the media to the client, results in a media format referred to as a “distribution media format,” or simply, the “distribution format.” In general, these steps should be performed only once, if performed at all for a given media data object, if the network has access to information to indicate that the client will need the transformed and or streamed media object for multiple occasions that otherwise would trigger the transformation and streaming of such media multiple times. That is, the processing and transfer of data for transformation and streaming of media is generally regarded as a source of latency with the requirement for expending potentially significant amount of network and or compute resources. Hence, a network design that does not have access to information to indicate when a client potentially already has a particular media data object stored in its cache or stored locally with respect to the client, will perform sub-optimally to a network that does have access to such information.

For legacy presentation devices, the distribution format may be equivalent or sufficiently equivalent to the “presentation format” ultimately used by the client presentation device to create the presentation. That is, a presentation media format is a media format whose properties (resolution, framerate, bit-depth, color gamut, etc, . . . ) are closely tuned to the capabilities of the client presentation device. Some examples of distribution vs. presentation formats include: a High-Definition (HD) video signal (1920 pixel columns×1080 pixel rows) distributed by a network to an Ultra-high-definition (UHD) client device with resolution (3840 pixel columns×2160 pixel rows). In this scenario, the UHD client will apply a process called “super-resolution” to the HD distribution format to increase the resolution of the video signal from HD to UHD. Thus the final signal format that is presented by the client device is the “presentation format” which, in this example, is a UHD signal, whereas the HD signal comprises the distribution format. In this example, the HD signal distribution format is very similar to the UHD signal presentation format because both signals are in a rectilinear video format, and the process to convert the HD format to a UHD format is a relatively straightforward and easy process to perform on most legacy client devices.

Or, the preferred presentation format for the targeted client device may be significantly different from the ingest format received by the network. And, the client may have access to sufficient compute, storage, and bandwidth resources to transform the media from the ingest format into the necessary presentation format suitable for presentation by the client. In this scenario, the network may bypass the step of reformatting the ingested media, e.g. “transcoding” the media, from a format A to a format B simply because the client has access to sufficient resources to perform all media transforms without the network having to do so a prioi. However, the network may still perform the step of fragmenting and packaging the ingest media so that the media may be streamed to the client. Another alternative is that the ingested media received by the network is significantly different from the client's preferred presentation format, and the client does not have access to sufficient compute, storage, and or bandwidth resources to convert the media to the preferred presentation format. In such a scenario, the network may assist the client by performing some or all of the transformation from the ingest format into a format that is either equivalent or nearly equivalent to the client's preferred presentation format on behalf of the client. In some architecture designs, such assistance provided by the network on behalf of the client is commonly referred to as “split rendering” or “adaptation” of the media.

In the last decade, immersive media-capable devices have been introduced to the consumer market, including head-mounted displays, augmented-reality glasses, hand-held controllers, multi-view displays, haptic gloves, and game consoles. Likewise, holographic displays and other forms of volumetric displays are poised to emerge into the consumer market within the next three to five years. Despite immediate or imminent availability of these devices, a coherent end-to-end ecosystem for the distribution of immersive media over commercial networks has failed to materialize for several reasons. One of the impediments to realizing a coherent end-to-end ecosystem for distribution of immersive media over commercial networks is that the client devices that serve as end-points for such a distribution network for immersive displays are all very diverse. Some of them support certain immersive media formats while others do not. Some of them are capable of creating an immersive experience from legacy raster-based formats, while others cannot. Unlike a network designed only for distribution of legacy media, a network that must support a diversity of display clients that needs a significant amount of information pertaining to the specifics of each of the client's capabilities, and the formats of the media to be distributed, before such network can employ an adaptation process to translate the media into a format suitable for each target display and corresponding application. At a minimum, such network would need access to information that directly describes characteristics of each target display and of the media itself in order to ascertain interchange of the media. That is, media information may be represented differently depending on how the media is organized according to a variety of media formats; a network that supports heterogeneous clients and immersive media formats would need access to information that enables it to identify when one or more media representations (according to specifications of media formats) are essentially representing the same media information. Thus a major challenge for distribution of heterogeneous media to heterogeneous client end points is to achieve media “interchange.”

In other words, during the development of Independent Mapping Space, it has become clear that the architecture as presented in the CD ballot of Part 28, of ISO/IEC 23090 Part 28, needs to be improved to better handle the goal of creating an interchangeable representation for many scene-based formats. This contribution proposes an update to the IMS architecture in Part 28, with the suggestion that this update be adopted into Part 28 prior to the planned DIS ballot, i.e., as an output of MPEG 147. It is also important to note that at the time of this disclosure, the first version of Part 28 is still being developed by ISO/IEC JTC1 SC29/WG7 (MPEG's Working Group 7). The most recent version of the specification published by WG7 is ISO/IEC JTC1/SC29 WG7 N00870, which was published by WG7 on 17 Jun. 2024. Document N00870 does not provide a full specification of the Independent Mapping Space (IMS), in particular with respect to the goal of organizing the metadata in terms of descriptors of logical relationships between objects within scene-based media vs. descriptors of the physical organization of the media vs. descriptors of how the media should be rendered.

A second problem to address in a translation process is to annotate the individual objects and other parts of the scene graph for a specific instance of a scene graph, e.g., a scene graph representation using format X, with the metadata comprising the IMS. That is, the metadata used to annotate a specific instance of a scene graph should be directly related to the corresponding individual media objects, media attributes, and rendering features of the scene graph format X. With respect to the above problem of defining metadata to facilitate a translation from one scene graph format to another, one approach is to leverage the availability of unique labels and metadata that are defined within the ITMF suite of specifications to create an Independent Mapping Space such as planned in the ongoing development of ISO/IEC 23090 Part 28. Such a space serves to facilitate media interchange from one format to another while preserving or closely preserving the information represented by the different media formats.

However, the ITMF itself was originally designed to be used as a format to define media, and not to label other media formats with metadata for the purposes of asset interchange or translation. As such, one missing aspect of the ITMF with respect to its usage as a metadata format for the purposes of facilitating asset interchange is a means to describe the results of the translation process within or about the media that is translated. And the above descriptions are not admissions of prior art but are instead provided merely as background descriptions from which one of ordinary skill in the art would recognize a background of technical problems and difficulties associated with and improved over by embodiments described herein.

### SUMMARY

The techniques provided herein describe a collection of metadata to create a standardized set of metadata for the purposes of representing or describing the process of translating media assets with another collection of metadata for the purposes of media asset interchange.

There is provided a method (executable by a processor) for, a device including at least one memory configured to store program code and at least one processor configured to read the program code and operate as instructed by the program code to, and a non-transitory computer readable medium storing instructions that, when executed by at least one processor of a device for streaming immersive media, cause at least one processor to ingest media content of the immersive media and comprising Independent Mapping Space (IMS) metadata of a scene of the media content; extend the IMS metadata by annotating the IMS metadata with Immersive Technologies Media Format (ITMF) metadata representing at least an ITMF node code point; and stream the media content of the immersive media based on extending the IMS metadata annotated with the ITMF metadata.

Annotating the IMS metadata with the ITMF metadata may include identifying a node within the scene-based media depending on an IMS label “ims.logical.material.specular”.

The ITMF metadata further may represent a list of pins and attributes comprising pin and attribute code point values.

Extending the IMS metadata further may include: determining whether a format of any of the scene and an asset of the scene indicates a mechanism to store annotation metadata; and annotating the IMS metadata based on whether the mechanism is indicated by any of the scene and the assert of the scene and by storing IMS labels to a media file.

Extending the IMS metadata further may include: obtaining a value of an “ims.process.annotation.next.id” keyword of an IMS header; assigning an unsigned integer values to IMS labels stored in a media file as a value portion of a keyword and a value pair in which the keyword is “mpeg-id”; storing an annotation header to the media file based on determining that the media file lacks an annotation header; storing annotation labels to the media file as a value portion of the “ims.process.annotation.next.id” keyword of the IMS header; creating a 32-character value string, as a 128 bit value represented as a 32-character ASCII string, of the media file, and the media files contains any of an annotated scene and a media asset of the content of the scene; and replacing a value portion of an “ims.process.annotation.hash” keyword within the annotation header with the 32-character value string.

The annotation header may include an IMS label keyword and value pairs, for an initial annotation of scene media of the scene, according to the following format:
ims.process.annotation.hash:#######32-character-hash########
ims.process.annotation.ims.version:1.0
ims.process.annotation.next.id:0.

Annotating the scene graph may include at least one of: fixity checking for an already IMS metadata annotated version of the media content, and providing an update to the already IMS metadata annotated version of the media content.

### BRIEF DESCRIPTION OF THE DRAWINGS

Further features, nature, and various advantages of the disclosed subject matter will be more apparent from the following detailed description and the accompanying drawings in which:

FIG. 1 is a schematic illustration of the flow of media through a network for distribution to a client according to one or more embodiments herein;

FIG. 2 is a schematic illustration of the flow of media through a network in which a decision making process is employed to determine if the network should transform the media prior to distributing the media to the client according to one or more embodiments herein;

FIG. 3 (and FIG. 3(Cont.) (“Cont.” being short for “continued”)) is a schematic illustration of an embodiment of a data-model for the representation and streaming of timed immersive media where such timed immersive media contains lists of assets that are reused across a set of N scenes according to one or more embodiments herein;

FIG. 4 (and FIG. 4(Cont.)) is a schematic illustration of an embodiment of a data-model for the representation and streaming of untimed immersive media where such untimed immersive media contains lists of assets that are reused across a set of 5 scenes according to one or more embodiments herein;

FIG. 5 is a schematic illustration of a process of capturing a natural scene and converting it to a representation that can be used as an ingest format for a network that serves heterogenous client end-points according to one or more embodiments herein;

FIG. 6 is a schematic illustration of a process of using 3D modeling tools and formats to create a representation of a synthetic scene that can be used as an ingest format for a network that serves heterogenous client end-points. In this example, the scene graph is optionally annotated with IMS metadata according to one or more embodiments herein;

FIG. 7 is a system diagram of computer system according to one or more embodiments herein;

FIG. 8 (and FIG. 8(Cont.)) is a schematic illustration of a network that serves a plurality of heterogenous client end-points according to one or more embodiments herein;

FIG. 9 is a schematic illustration of a network providing adaptation information about the specific media represented in the media ingest format, e.g., prior to the network's process of adapting the media for consumption by a specific immersive media client end-point. In this illustration, the ingested scene graph is optionally annotated according to one or more embodiments herein;

FIG. 10 is a system diagram of a media adaptation process consisting of a media render-converter that converts a source media from its ingest format to a specific format suitable for a specific client end-point. In this diagram, the scene graph is optionally annotated according to one or more embodiments herein;

FIG. 11 is a schematic illustration of a network formatting the adapted source media into a data model suitable for representation and streaming according to one or more embodiments herein;

FIG. 12 is a system diagram of a media streaming process that fragments the data model of FIG. 12 into the payloads of network protocol packets according to one or more embodiments herein;

FIG. 13 is a sequence diagram of a network adapting a specific immersive media in an ingest format to a streamable and suitable distribution format for a specific immersive media client end-point according to one or more embodiments herein;

FIG. 14 (and FIG. 14(Cont.)) depicts an example of an architecture for physical organization of scene-based media with references to each physical object according to one or more embodiments herein;

FIG. 15 depicts an example of a scene graph that is annotated where such annotation is placed into the human-readable portion of a scene graph architecture according to one or more embodiments herein;

FIG. 16 depicts an example of a scene graph that is annotated where such annotation is placed into a binary (not human-readable) portion of a scene graph architecture according to one or more embodiments herein;

FIG. 17 depicts an example of a scene graph architecture without distinction between geometric structure, physical structure, and processing instructions according to one or more embodiments herein;

FIG. 18 depicts a sample architecture “distilled” into three salient components comprised of geometric information, physical storage information, and processing information according to one or more embodiments herein;

FIG. 19 depicts a hierarchical organization of scene-graph information that can be applied to create a serialized result according to one or more embodiments herein;

FIG. 20 depicts the use of the organization in FIG. 19 to distinguish between geometric, physical storage, and real-time processing information according to one or more embodiments herein;

FIG. 21 depicts an embodiment of metadata to encapsulate the physical storage information of the architecture according to one or more embodiments herein;

FIG. 22 depicts an example of a canonical representation of IMS geometric objects within the scene according to one or more embodiments herein;

FIG. 23 illustrates, as an example for an application for the disclosed subject matter, the placement of a video encoder and decoder in a streaming environment according to one or more embodiments herein;

FIG. 24 illustrates an example of mapping IMS subsystem identifiers to one or more ITMF nodes according to one or more embodiments herein;

FIG. 25 illustrates an example of IMS subsystems to organized IMS metadata according to one or more embodiments herein;

FIG. 26 illustrates an example of translation metadata subsystem nodes for IMS (not from ITMF) according to one or more embodiments herein; and

FIG. 27 illustrates an example of annotation subsystem for annotation for asset interchange according to one or more embodiments herein.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

The techniques provided herein describe an embodiment of metadata to create a standardized interchangeable representation for scene-based media such as described in ISO/IEC 23090 Part 28 to facilitate interchange of 3D scene-based media. Such an embodiment further defines an architecture for the metadata in which the metadata is organized into three categories: 1) a description of the geometry in the scene 2) a description of the physical features of the binary objects within the scene (to facilitate read and write access of the media), and 3) a description of the instructions (e.g., for a renderer or presentation engine) to process the media into the desired experience. Such an architecture and corresponding organization facilitates the interchange of scene-based media by providing additional context for how the media should be translated and or annotated for interchange. Such metadata to describe the features of the physical organization are further described in the disclosed techniques.

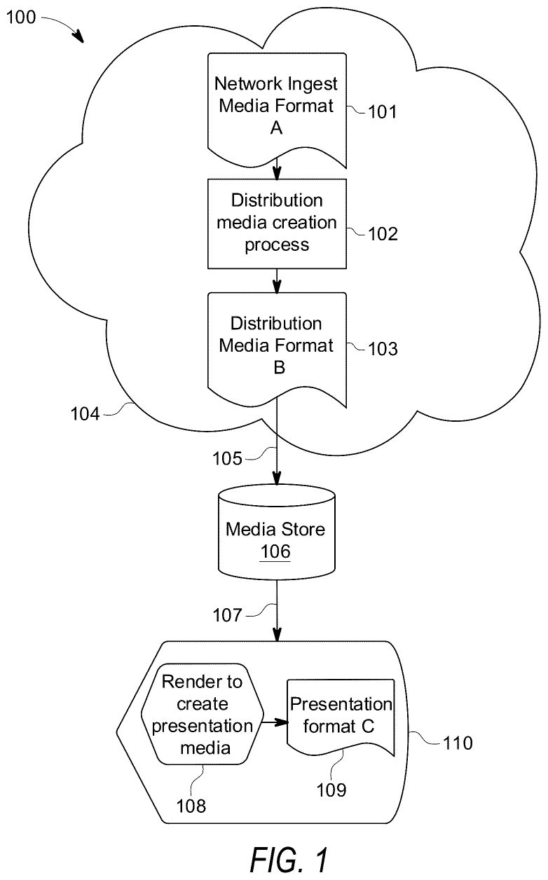

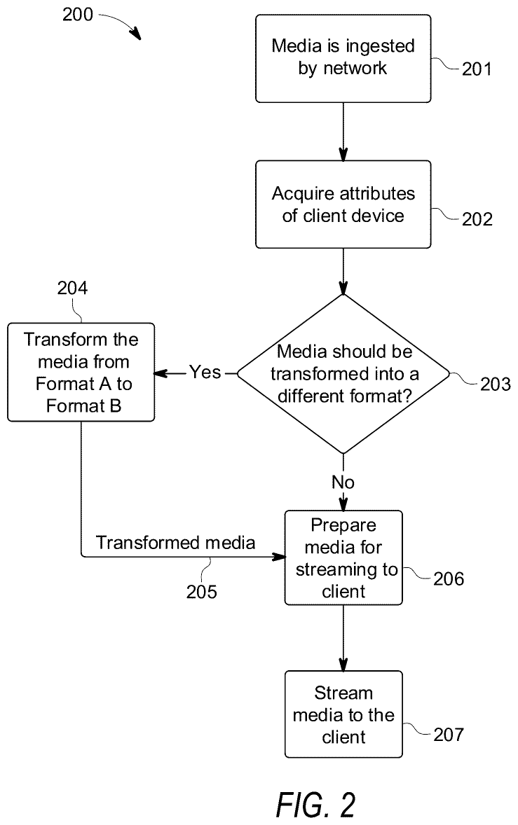

FIG. 1 illustrates a Network Media Flow Process 100 including a general sequence of steps that may be executed by a network cloud or edge device according to one or more embodiments herein. FIG. 2 depicts a Media Transform Decision Making Process 200 that illustrates the network logic flow for processing ingested media through either a manual or automated process within the network according to one or more embodiments herein.

An important aspect to the logic in FIG. 2 is the decision making process that may be performed either by a human, or by an automated process. That decision making step must determine whether the media can be streamed in an original ingested format A, or if it must be transformed into a different format B to facilitate the presentation of the media by the client.

Such a decision making process may require access to information where that information describes aspects or features of the ingest media, in such a way so as to aid the process to make an optimal choice, i.e., to determine if a transformation of the ingest media is needed prior to streaming the media to the client, or if the media should be streamed in its original ingest format A directly to the client.

Given each of the above scenarios where transformations of media from a format A to another format may be done either entirely by the network, entirely by the client, or jointly between both the network and the client, e.g., for split rendering, it becomes apparent that a lexicon of attributes that describe a media format may be needed so that both the client and network have complete information to characterize the media and the work that must be done.

A lexicon for the media format, as described above, may be leveraged by a transformation processor. Such a lexicon may further be organized into separate categories that describe the logical relationships amongst the objects in scene-based media, e.g., how the branches of the tree relate to the trunk of the tree; the physical storage characteristics of the scene-based media, e.g., how the data within a binary buffer is to be accessed or read; and the instructions for how to render the media, e.g., how to animate the objects in the scene or the filters to be applied to objects, or alternate output variables (for saving and storage of intermediate values during the serialization of the scene).

Furthermore, a lexicon that provides descriptions of a client's capabilities, e.g., in terms of available compute resources, available storage resources, and access to bandwidth may likewise be needed. Even further, a mechanism to characterize the level of compute, storage, or bandwidth complexity of an ingest format is needed so that a network and client may jointly, or singely, determine if or when the network may employ a split-rendering step for distributing the media to the client. Additionally, if the transformation and or streaming of a particular media object that is or will be needed by the client to complete the presentation has already been done as part of the work to process prior scenes for the presentation, then the network might altogether skip the steps of transform and or streaming of the ingest media assuming that the client still has access or availability to the media that was previously streamed to the client. Finally, if the transformation from a Format A to another format is determined to be a necessary step to be performed either by or on behalf of the client, then a prioritization scheme for ordering the transformation processes of individual assets within the scene may benefit an intelligent and efficient network architecture.

One example of such a lexicon of descriptors to characterize the media is the so-called Independent Mapping Space (IMS) nomenclature that is designed to help translate from one scene-graph format to another, and potentially entirely different, scene-graph format. The Independent Mapping Space is currently under development as Part 28 of the ISO/IEC 23090 suite of standards; such suite is informally known as “MPEG-I.” According to the scope of Part 28, the IMS is comprised of metadata and other information that describe commonly used aspects of scene-based media formats. For example, scene-based media may commonly provide mechanisms to describe the geometry of a visual scene. One aspect of the IMS in ISO/IEC 23090 Part 28 is to provide standards-based metadata that may be used to annotate the human-readable portion of a scene graph so that the annotation guides the translation from one format to another, i.e. from one scene geometry description to another scene geometry description. Such annotation may also be attached to the scene graph as a separate binary component. The same guided translation may be true of cameras; i.e., many scene graph formats provide a means to describe the features of a virtual camera that can be used as part of the rendering process to create a viewport into the scene. The IMS in Part 28 likewise is intended to provide metadata to describe commonly used camera types. The purpose of the IMS is to provide a nomenclature that can be used to describe the commonly-used aspects across multiple scene graph formats, so that the translation from one format to another is guided by the IMS. Such a translation enables asset interchange across multiple clients. Another important aspect of ISO/IEC 23090 Part 28 is that there is intentionally no specified way to complete the translation from one format to another format. Rather, the IMS simply provides guidance for how to characterize common features of all scene graphs. Apart from the geometry and camera features of a scene graph, other common features of scenes include lighting, and object surface properties such as albedo, materials, roughness, and smoothness.

With respect to the goal of translating one scene graph format X to another scene graph format Y, there are at least two potential problems to solve as follows. A first problem is to define a generic translation between two representations of the same type of media object, media attribute, or rendering function to be performed. For example, the IMS metadata for a static mesh object may be expressed with a generic code such as: IMS_STATIC_MESH. A scene graph represented by the syntax of format X may refer to a static mesh using an identifier such as: FORMAT_X_STATIC_MESH, whereas a scene graph represented by the syntax of format Y may refer to a static mesh using an identifier such as: FORMAT_Y_STATIC_MESH. The definition of a generic translation via the use of the IMS in ISO/IEC 23090 Part 28 may include the mappings of FORMAT_X_STATIC_MESH to IMS_STATIC_MESH, and FORMAT_Y_STATIC_MESH to IMS_STATIC_MESH. Hence, a generic translation from format X static mesh to format Y static mesh may be facilitated through the use of the metadata IMS_STATIC_MESH from IMS of ISO/IEC 23090 Part 28.

It is important to note and reiterate that at the time of this disclosure, the first version of Part 28 is still being developed by ISO/IEC JTC1 SC29/WG7 (MPEG's Working Group 7). The most recent version of the specification published by WG7 is ISO/IEC JTC1/SC29 WG7 N00870, which was published by WG7 on 17 Jun. 2024. Document N00870 does not provide a full specification of the Independent Mapping Space (IMS), in particular with respect to the goal of organizing the metadata in terms of descriptors of logical relationships between objects within scene-based media vs. descriptors of the physical organization of the media vs. descriptors of how the media should be rendered.

A second problem to address in a translation process is to annotate the individual objects and other parts of the scene graph for a specific instance of a scene graph, e.g., a scene graph representation using format X, with the metadata comprising the IMS. That is, the metadata used to annotate a specific instance of a scene graph should be directly related to the corresponding individual media objects, media attributes, and rendering features of the scene graph format X.

With respect to the above problem of defining metadata to facilitate a translation from one scene graph format to another, one approach is to leverage the availability of unique labels and metadata that are defined within the ITMF suite of specifications to create an Independent Mapping Space such as planned in the ongoing development of ISO/IEC 23090 Part 28. Such a space serves to facilitate media interchange from one format to another while preserving or closely preserving the information represented by the different media formats.

However, the ITMF itself was originally designed to be used as a format to define media, and not to label other media formats with metadata for the purposes of asset interchange or translation. As such, one missing aspect of the ITMF with respect to its usage as a metadata format for the purposes of facilitating asset interchange is a means to describe the results of the translation process within or about the media that is translated.

Definitions are provided as follows. Scene graph: general data structure commonly used by vector-based graphics editing applications and modern computer games, which arranges the logical and often (but not necessarily) spatial representation of a graphical scene; a collection of nodes and vertices in a graph structure. Scene: in the context of computer graphics, a scene is a collection of objects (e.g., 3D assets), object attributes, and other metadata that comprise the visual, acoustic, and physics-based characteristics describing a particular setting that is bounded either by space or time with respect to the interactions of the objects within that setting. Node: fundamental element of the scene graph comprised of information related to the logical or spatial or temporal representation of visual, audio, haptic, olfactory, gustatory, or related processing information; each node shall have at most one output edge, zero or more input edges, and at least one edge (either input or output) connected to it.

Base Layer: a nominal representation of an asset, usually formulated to minimize the compute resources or time needed to render the asset, or the time to transmit the asset over a network. Enhancement Layer: a set of information that when applied to the base layer representation of an asset, augments the base layer to include features or capabilities that are not supported in the base layer. Attribute: metadata associated with a node used to describe a particular characteristic or feature of that node either in a canonical or more complex form (e.g. in terms of another node). Binding LUT: a logical structure that associates metadata from the IMS of ISO/IEC 23090 Part 28 with metadata or other mechanisms used to describe features or functions of a specific scene graph format, e.g. ITMF, glTF, Universal Scene Description.

Container: a serialized format to store and exchange information to represent all natural, all synthetic, or a mixture of synthetic and natural scenes including a scene graph and all of the media resources that are required for rendering of the scene. Serialization: the process of translating data structures or object state into a format that can be stored (for example, in a file or memory buffer) or transmitted (for example, across a network connection link) and reconstructed later (possibly in a different computer environment). When the resulting series of bits is reread according to the serialization format, it can be used to create a semantically identical clone of the original object. Renderer: a (typically software-based) application or process, based on a selective mixture of disciplines related to: acoustic physics, light physics, visual perception, audio perception, mathematics, and software development, that, given an input scene graph and asset container, emits a typically visual and/or audio signal suitable for presentation on a targeted device or conforming to the desired properties as specified by attributes of a render target node in the scene graph. For visual-based media assets, a renderer may emit a visual signal suitable for a targeted display, or for storage as an intermediate asset (e.g. repackaged into another container i.e. used in a series of rendering processes in a graphics pipeline); for audio-based media assets, a renderer may emit an audio signal for presentation in a multi-channel loudspeaker and/or binauralized headphones, or for repackaging into another (output) container. Popular examples of renderers include the real-time rendering features of the game engines Unity and Unreal Engine. Evaluate: produces a result (e.g. similar to evaluation of a Document Object Model for a webpage) that causes the output to move from an abstract to a concrete result.

Scripting language: An interpreted programming language that can be executed by a renderer at runtime to process dynamic input and variable state changes made to the scene graph nodes, which affect rendering and evaluation of spatial and temporal object topology (including physical forces, constraints, inverse kinematics, deformation, collisions), and energy propagation and transport (light, sound). Shader: a type of computer program that was originally used for shading (the production of appropriate levels of light, darkness, and color within an image) but which now performs a variety of specialized functions in various fields of computer graphics special effects or does video post-processing unrelated to shading, or even functions unrelated to graphics at all. Path Tracing: a computer graphics method of rendering three-dimensional scenes such that the illumination of the scene is faithful to reality.

Timed media: Media that is ordered by time; e.g., with a start and end time according to a particular clock. Untimed media: Media that is organized by spatial, logical, or temporal relationships; e.g., as in an interactive experience that is realized according to the actions taken by the user(s). Neural Network Model: a collection of parameters and tensors (e.g., matrices) that define weights (i.e., numerical values) used in well defined mathematical operations applied to the visual signal to arrive at an improved visual output which may include the interpolation of new views for the visual signal that were not explicitly provided by the original signal. OCS: The human-readable portion of an ITMF scene graph that uses unique identifiers denoted as ‘id=nnn’ where ‘nnn’ is an integer value. IMS: Independent Mapping Space metadata that is standardized in ISO/IEC 23090 Part 28. Pin: input and output parameters for nodes of a scene graph. Attributes: characteristics of a given node that are immutable by other nodes.

In the last decade, a number of immersive media-capable devices have been introduced into the consumer market, including head-mounted displays, augmented-reality glasses, hand-held controllers, multi-view displays, haptic gloves, and game consoles. Likewise, holographic displays and other forms of volumetric displays are poised to emerge into the consumer market within the next three to five years. Despite the immediate or imminent availability of these devices, a coherent end-to-end ecosystem for the distribution of immersive media over commercial networks has failed to materialize for several reasons.

One of the impediments to realizing a coherent end-to-end ecosystem for distribution of immersive media over commercial networks is that the client devices that serve as end-points for such a distribution network for immersive displays are all very diverse. Some of them support certain immersive media formats while others do not. Some of them are capable of creating an immersive experience from legacy raster-based formats, while others cannot. Unlike a network designed only for distribution of legacy media, a network that must support a diversity of display clients needs a significant amount of information pertaining to the specifics of each of the client's capabilities, and the formats of the media to be distributed, before such network can employ an adaptation process to translate the media into a format suitable for each target display and corresponding application. At a minimum, such a network would need access to information that directly describes the characteristics of each target display and of the media itself in order to ascertain interchange of the media. That is, media information may be represented differently depending on how the media is organized according to a variety of media formats; a network that supports heterogeneous clients and immersive media formats would need access to information that enables it to identify when one or more media representations (according to specifications of media formats) are essentially representing the same media information. Thus a major challenge for distribution of heterogeneous media to heterogeneous client end points is to achieve media “interchange.”

Media interchange can be regarded as the preservation of a property of the media after the media has been converted (or adapted as described above in the conversion from a Format A to a Format B). That is, the information represented by a Format A is either not lost or is closely approximated by a representation by Format B. Immersive media may be organized into “scenes” that are described by scene graphs, which are also known as scene descriptions. To date, there are a number of popular scene-based media formats including: FBX, USD, Alembic, and glTF. Such scenes refer to scene-based media as described above. The scope of a scene graph is to describe visual, audio, and other forms of immersive assets that comprise a particular setting that is part of a presentation, for example, the actors and events taking place in a particular location in a building that is part of a presentation, e.g., movie. A list of all scenes that comprise a single presentation may be formulated into a manifest of scenes.

The disclosed subject matter addresses the need for an intermediate media representation that facilitates the translation of scene-based media from one scene format to another. Such a representation may, through its organization, provide context to a translation process by identifying features that are common to a variety of scene-based media. Such features may include, as an example: clearly identifying aspects of scene-based media that define the geometry of the scene; clearly identifying aspects of the scene-based media that describe how to read and or write the binary data corresponding to the scene; clearly identifying the aspects of the scene that describe how the media should be rendered, animated, or otherwise processed by a presentation engine. An organization of an interchangeable scene representation into these categories, may provide additional context (to media translators or other network components) than a representation that does not distinguish between these aspects of scene-based media. Aspects related to the physical organization of such an architecture are further disclosed herein.

The disclosed subject matter addresses the need for an embodiment of an Independent Mapping Space, i.e., to address the requirements and goals (to achieve media interchange) for ISO/IEC 23090 Part 28 (currently still in development). Such an embodiment is comprised of a collection of “subsystems” in which each subsystem is comprised of related nodes, pins, and attributes commonly used to represent scene-based media. In general, each subsystem is organized in a manner similar to the organization of nodes within the ITMF with the exception of nodes related to information that describes the explicit organization of scene graph. There is currently no corresponding ITMF subsystem of nodes that explicitly defines the organization of the ITMF graph. The subject matter disclosed herein creates such a subsystem in order to define a complete collection of subsystems for the framework comprising IMS metadata for the purposes of immersive media interchange. Note that the remainder of the disclosed subject matter assumes, without loss of generality, that the process of adapting (i.e., to achieve media interchange) an input immersive media source to match the input media requirements for a specific end-point client device is the same as, or similar to, the process of adapting the same input immersive media source to the specific application that is being executed on the specific client end-point device. That is, the problem of adapting an input media source to the characteristics of an end-point device are of the same complexity as the problem to adapt a specific input media source to the characteristics of a specific application. Further note that the term media object and media asset may be used interchangeably, both referring to a specific instance of a specific format of media data.

FIG. 1 is a schematic illustration of a Media Flow Process 100 of media, through a network, for distribution to a client. In FIG. 1, processing of an Ingest Media Format A is performed by a “cloud” or edge process 104. Note that the same processing may be performed a prioi in a manual process or by a client, just as well. Ingest Media 101 is obtained from a content provider. Process 102 performs any necessary transformations or conditioning of the ingested media to create a potentially alternative representation of the media as a Distribution Format B. Media formats A and B may or may not be representations following the same syntax of a particular media format specification, however the Format B is likely to be conditioned by Process 103 into a scheme that facilitates the distribution of the media over a network protocol such as TCP or UDP. Such “streamable” media is depicted in 105 as media that is streamed to a Media Store 106. Client 110 accesses the media from Store 106 via a Fetching Mechanism 107 (e.g. ISO/IEC 23009 Dynamic Adaptive Streaming over HTTP). Client 110 has access to some rendering capabilities depicted as 108. Such render capabilities 108 may be rudimentary or likewise, sophisticated, depending on the type of client 110 that is being targeted. Render process 108 creates Presentation Media 109 that may or may not be represented according to a third format specification, e.g., Format C.

FIG. 2 is a schematic illustration of a flow of media through a network in which a Media Transform Decision Making Process 200 is employed to determine if the network should transform the media prior to distributing the media to a client. In FIG. 2, Ingest Media 201 represented in Format A is provided by a content provider to the network. Process 202 acquires attributes that describe the processing capabilities of targeted client. Decision making process 203 is employed to determine if the network or the client should perform any format conversions for any of the media assets contained within the Ingested Media 201, e.g., such as a conversion of a particular media object from a Format A to a Format B, prior to the media being streamed to the client. If any of the media assets should be transformed by the network, then the network employs process 204 to transform the media object from Format A to Format B. Transformed media 205 is the output from process 204. The transformed media is merged into the Preparation process 206 to prepare the media to be streamed to client. Process 207 streams the media to the client or to the media store (e.g., Media Store 106 in FIG. 1).

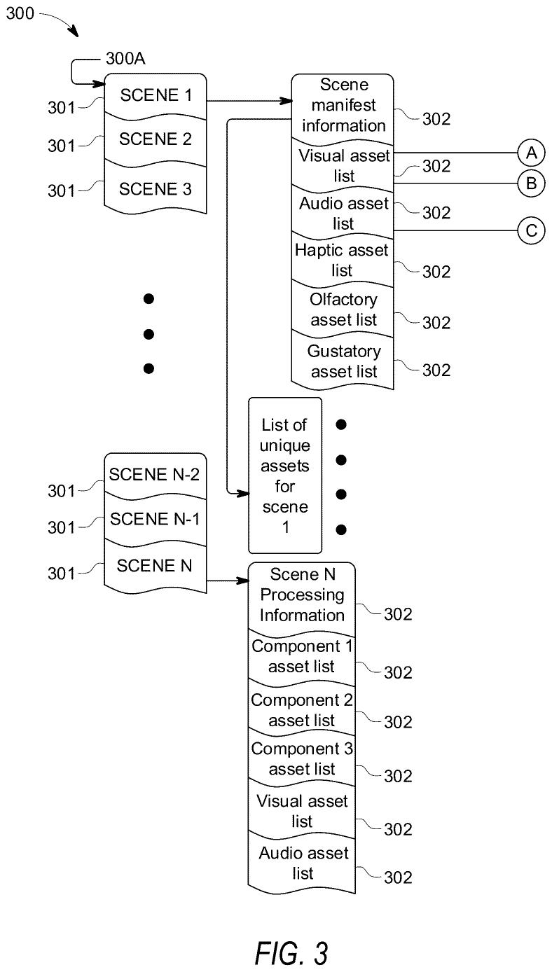

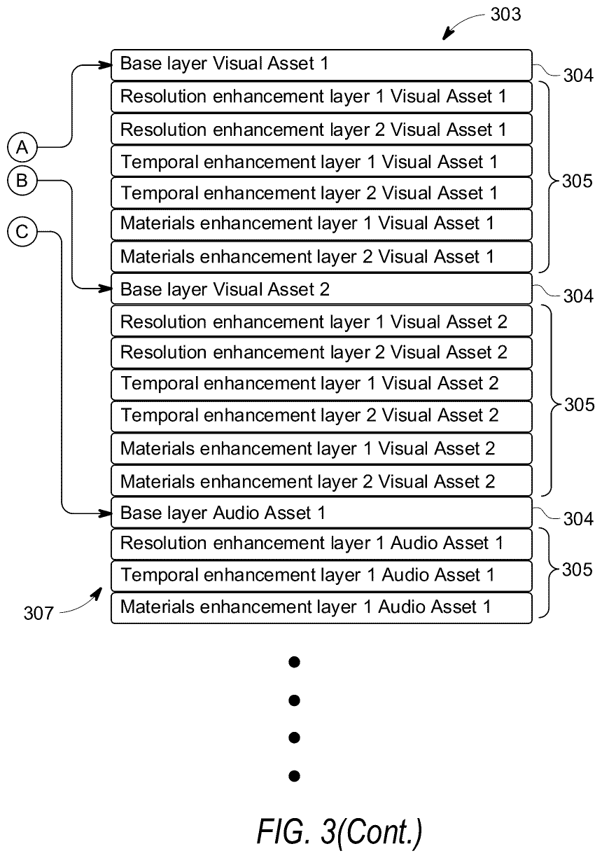

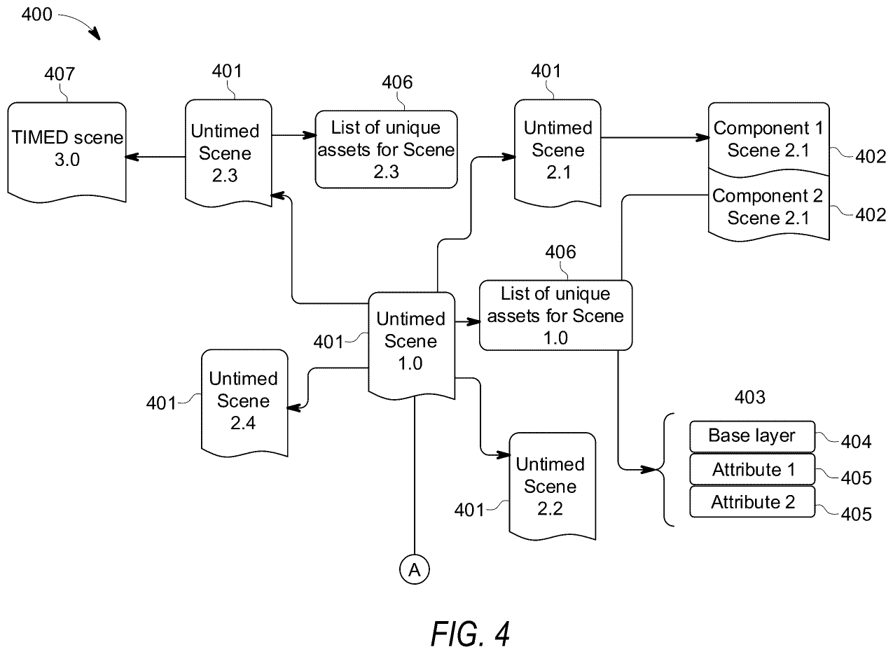

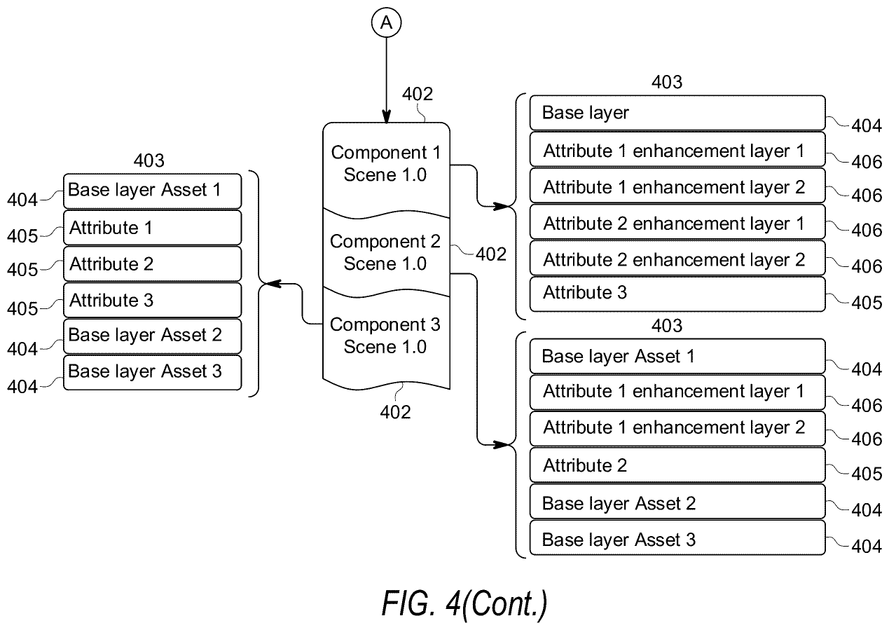

FIG. 3 (which includes FIG. 3 connected to FIG. 3(Cont.) by connectors A, B, and C) depicts a Timed Media Representation 300 as an example representation of a streamable format for heterogenous immersive media that is timed. FIG. 4 (which includes FIG. 4 connected to FIG. 4(Cont.) by a connector A) depicts an Untimed Media Representation 400 as an example representation of a streamable format for heterogeneous immersive media that is untimed. Both figures refer to a Scene; FIG. 3 refers to Scene 301 for timed media and FIG. 4 refers to Scene 401 for untimed media. For both cases, the Scene may be embodied by various scene representations, or scene descriptions. For example, in some immersive media designs, a scene may be embodied by a Scene Graph, or as a Multi-Plane Image (MPI), or as a Multi-Spherical Image (MSI). Both the MPI and MSI techniques are examples of technologies that aid in the creation of display-agnostic scene representations for natural content, i.e., images of the real world captured simultaneously from one or more cameras. Scene Graph technologies, on the other hand, may be employed to represent both natural and computer-generated imagery in the form of synthetic representations, however, such representations are especially compute-intensive to create for the case when the content is captured as natural scenes by one or more cameras. That is, scene graph representations of naturally-captured content are both time and compute-intensive to create, requiring complex analysis of natural images with techniques of photogrammetry or deep learning or both, in order to create synthetic representations that can subsequently be used to interpolate sufficient and adequate numbers of views to fill a target immersive client display's viewing frustum. As a result, such synthetic representations are presently impractical to consider as candidates for representing natural content, because they cannot practically be created in real-time for consideration of use cases that require real-time distribution. Nevertheless, at present, the best candidate representations for computer generated imagery is to employ the use of a scene graph with synthetic models, as computer generated imagery is created using 3D modeling processes and tools. Such a dichotomy in optimal representations of both natural and computer generated content suggests that the optimal ingest format for naturally-captured content is different from the optimal ingest format for computer generated content or for natural content that is not essential for real-time distribution applications. Therefore, the disclosed subject matter targets to be robust enough to support multiple ingest formats for visually immersive media, whether they are created naturally through the use of physical cameras or by a computer. The following are example technologies that embody scene graphs as a format suitable for representing visual immersive media that is created using computer generated techniques, or naturally captured content for which deep learning or photogrammetry techniques are employed to create the corresponding synthetic representations of a natural scene, i.e., not essential for real-time distribution applications.

i. ORBX by OTOY: ORBX by OTOY is one of several scene graph technologies that is able to support any type of visual media, timed or untimed, including ray-traceable, legacy (frame-based), volumetric, and other types of synthetic or vector-based visual formats. ORBX is unique from other scene graphs because ORBX provides native support for freely available and/or open source formats for meshes, point clouds, and textures. ORBX is a scene graph that has been intentionally designed with the goal of facilitating interchange across multiple vendor technologies that operate on scene graphs. Moreover, ORBX provides a rich materials system, support for Open Shader Language, a robust camera system, and support for Lua Scripts. ORBX is also the basis of the Immersive Technologies Media Format published for license under royalty-free terms by the Immersive Digital Experiences Alliance (IDEA). In the context of real time distribution of media, the ability to create and distribute an ORBX representation of a natural scene is a function of the availability of compute resources to perform a complex analysis of the camera-captured data and synthesis of the same data into synthetic representations. To date, the availability of sufficient compute for real-time distribution is not practical, but nevertheless, not impossible. ii. Universal Scene Description by Pixar: Universal Scene Description (USD) by Pixar is another well-known, and mature scene graph that is popular in the VFX and professional content production communities. USD is integrated into Nvidia's Omniverse platform which is a set of tools for developers for 3D model creation and rendering with Nvidia's GPUs. A subset of USD was published by Apple and Pixar as USDZ. USDZ is supported by Apple's ARKit. iii. glTF2.0 by Khronos: glTF2.0 is the most recent version of the “Graphics Language Transmission Format” specification written by the Khronos 3D Group. This format supports a simple scene graph format that is generally capable of supporting static (untimed) objects in scenes, including “png” and “jpeg” image formats. glTF2.0 supports simple animations, including support for translate, rotate, and scale, of basic shapes described using the glTF primitives, i.e. for geometric objects. glTF2.0 does not support timed media, and hence does not support video nor audio. iv. ISO/IEC 23090 Part 14 Scene Description is an extension of glTF2.0 that adds support for timed media, e.g., video and audio.

These designs for scene representations of immersive visual media are provided for example only, and do not limit the disclosed subject matter in its ability to specify a process to adapt an input immersive media source into a format that is suitable to the specific characteristics of a client end-point device. Moreover, any or all of the above example media representations cither currently employ or may employ deep learning techniques to train and create a neural network model that enables or facilitates the selection of specific views to fill a particular display's viewing frustum based on the specific dimensions of the frustum. The views that are chosen for the particular display's viewing frustum may be interpolated from existing views that are explicitly provided in the scene representation, e.g., from the MSI or MPI techniques, or they may be directly rendered from render engines based on specific virtual camera locations, filters, or descriptions of virtual cameras for these render engines. The disclosed subject matter is therefore robust enough to consider that there is a relatively small but well known set of immersive media ingest formats that is sufficiently capable to satisfy requirements both for real-time or “on-demand” (e.g., non-real-time) distribution of media that is either captured naturally (e.g., with one or more cameras) or created using computer generated techniques.

Interpolation of views from an immersive media ingest format by use of either neural network models or network-based render engines is further facilitated as advanced network technologies such as 5G for mobile networks, and fibre optical cable for fixed networks are deployed. That is, these advanced network technologies increase the capacity and capabilities of commercial networks because such advanced network infrastructures can support transport and delivery of increasingly larger amounts of visual information. Network infrastructure management technologies such as Multi-access Edge Computing (MEC), Software Defined Networks (SDN), and Network Functions Virtualization (NFV), enable commercial network service providers to flexibly configure their network infrastructure to adapt to changes in demand for certain network resources, e.g., to respond to dynamic increases or decreases in demand for network throughputs, network speeds, roundtrip latency, and compute resources. Moreover, this inherent ability to adapt to dynamic network requirements likewise facilitates the ability of networks to adapt immersive media ingest formats to suitable distribution formats in order to support a variety of immersive media applications with potentially heterogenous visual media formats for heterogenous client end-points. Immersive Media applications themselves may also have varying requirements for network resources including gaming applications which require significantly lower network latencies to respond to real-time updates in the state of the game, telepresence applications which have symmetric throughput requirements for both the uplink and downlink portions of the network, and passive viewing applications that may have increased demand for downlink resources depending on the type of client end-point display that is consuming the data. In general, any consumer-facing application may be supported by a variety of client end-points with various onboard-client capabilities for storage, compute, and power, and likewise various requirements for particular media representations.

The disclosed subject matter therefore enables a sufficiently equipped network, i.e., a network that employs some or all of the characteristics of a modern network, to simultaneously support a plurality of legacy and immersive media-capable devices according to features that are specified within that: i. Provide flexibility to leverage media ingest formats that are practical for both real-time and “on demand” use cases for the distribution of media. ii. Provide flexibility to support both natural and computer generated content for both legacy and immersive-media capable client end-points. iii. Support both timed and untimed media. iv. Provide a process for dynamically adapting a source media ingest format to a suitable distribution format based on the features and capabilities of the client end-point, as well as based on the requirements of the application. v. Ensure that the distribution format is streamable over IP-based networks. vi. Enable the network to simultaneously serve a plurality of heterogenous client end-points that may include both legacy and immersive media-capable devices and applications. vii. Provide an exemplary media representation framework that facilitates the organization of the distribution media along scene boundaries. An end-to-end embodiment of the improvements enabled by the disclosed subject matter is achieved according to the processing and components described in the detailed description as follows for example according to one or more exemplary embodiments.

FIG. 3 and FIG. 4 both employ a single exemplary encompassing distribution format that has been adapted from an ingest source format to match the capabilities of a specific client end-point. As described above, the media that is shown in FIG. 3 is timed and the media that is shown in FIG. 4 is untimed. The specific encompassing format is robust enough in its structure to accommodate a large variety of media attributes where each may be layered based on the amount of salient information that each layer contributes to the presentation of the media. Note that such a layering process is already a well-known technique in the current state-of-the-art as demonstrated with Progressive JPEG and scalable video architectures such as those specified in ISO/IEC 14496-10 (Scalable Advanced Video Coding).

i. The media that is streamed according to the encompassing media format is not limited to legacy visual and audio media, but may include any type of media information that is capable of producing a signal that interacts with machines to stimulate the human senses for sight, sound, taste, touch, and smell. ii. The media that is streamed according to the encompassing media format can be both timed or untimed media, or a mixture of both. iii. The encompassing media format is furthermore streamable by enabling a layered representation for media objects by use of a base layer and enhancement layer architecture. In one example, the separate base layer and enhancement layers are computed by application of multi-resolution or multi-tesselation analysis techniques for media objects in each scene. This is analogous to the progressively rendered image formats specified in ISO/IEC 10918-1 (JPEG), and ISO/IEC 15444-1 (JPEG2000), but not limited to raster-based visual formats. In an example embodiment, a progressive representation for a geometric object could be a multi-resolution representation of the object computed using wavelet analysis.

In another example of the layered representation of the media format, the enhancement layers apply different attributes to the base layer, such as refining the material properties of the surface of a visual object that is represented by the base layer. In another example, the attributes may refine the texture of the surface of the base layer object, such as changing the surface from a smooth to a porous texture, or from a matted surface to a glossy surface. In another example of the layered representation, the surfaces of one or more visual objects in the scene may be altered from being Lambertian to being ray-traceable.

In another example of the layered representation, the network will distribute the base-layer representation to the client so that the client may create a nominal presentation of the scene while the client awaits the transmission of additional enhancement layers to refine the resolution or other characteristics of the base representation. 4. The resolution of the attributes or refining information in the enhancement layers is not explicitly coupled with the resolution of the object in the base layer as it is today in existing MPEG video and JPEG image standards. 5. The encompassing media format supports any type of information media that can be presented or actuated by a presentation device or machine, thereby enabling the support of heterogenous media formats to heterogenous client end-points. In one embodiment of a network that distributes the media format, the network will first query the client end-point to determine the client's capabilities, and if the client is not capable of meaningfully ingesting the media representation then the network will either remove the layers of attributes that are not supported by the client, or adapt the media from its current format into a format that is suitable for the client end-point. In one example of such adaptation, the network would convert a volumetric visual media asset into a 2D representation of the same visual asset, by use of a Network-Based Media Processing protocol. In another example of such adaptation, the network may employ a neural network process to reformat the media to an appropriate format or optionally synthesize views that are needed by the client end-point. 6. The manifest for a complete or partially-complete immersive experience (live streaming event, game, or playback of on-demand asset) is organized by scenes which is the minimal amount of information that rendering and game engines can currently ingest in order to create a presentation. The manifest includes a list of the individual scenes that are to be rendered for the entirety of the immersive experience requested by the client. Associated with each scene are one or more representations of the geometric objects within the scene corresponding to streamable versions of the scene geometry. One embodiment of a scene representation refers to a low resolution version of the geometric objects for the scene. Another embodiment of the same scene refers to an enhancement layer for the low resolution representation of the scene to add additional detail, or increase tessellation, to the geometric objects of the same scene. As described above, each scene may have more than one enhancement layer to increase the detail of the geometric objects of the scene in a progressive manner. 7. Each layer of the media objects that are referenced within a scene is associated with a token (e.g., URI) that points to the address of where the resource can be accessed within the network. Such resources are analogous to CDN's where the content may be fetched by the client. 8. The token for a representation of a geometric object may point to a location within the network or to a location within the client. That is, the client may signal to the network that its resources are available to the network for network-based media processing.

FIG. 3 depicts a Timed Media Representation 300 including an embodiment of the encompassing media format for timed media as follows. The Timed Scene Manifest includes a list of Scenes 301. The Scene 301 refers to a list of Components 302 that separately describe processing information and types of media assets that comprise Scene 301. Components 302 refer to Assets 303 that further refer to Base Layers 304 and Attribute Enhancement Layers 305. A list of unique assets that have not been previously used in other scenes is provided in 307.

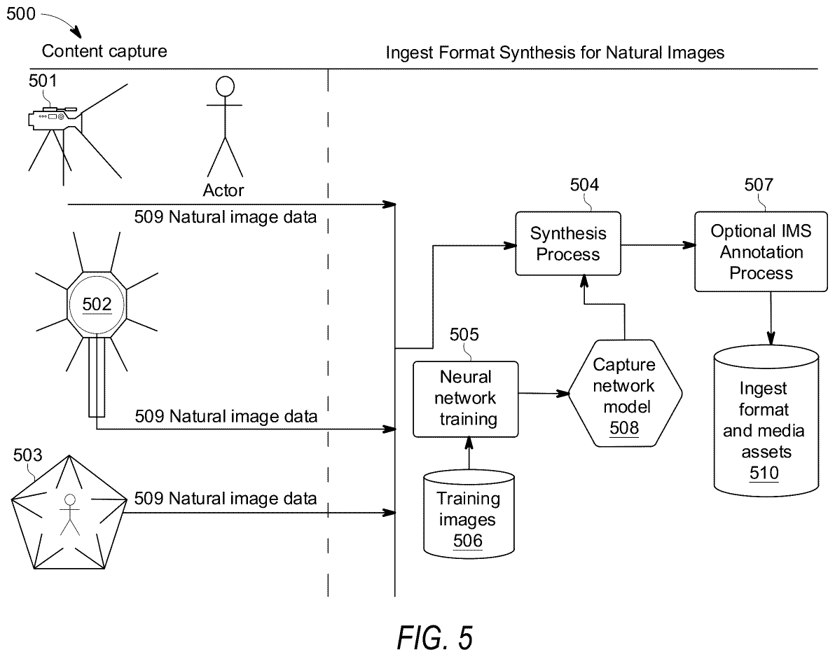

FIG. 4 depicts an Untimed Media Representation 400 including an embodiment of the encompassing media format for untimed media as follows. Information for Scene 401 is not associated with a start and end duration according to a clock. Scene 401 refers to a list of Components 402 that separately describe processing information and types of media assets that comprise Scene 401. Components 402 refer to Assets 403 that further refer to Base Layers 404 and Attribute Enhancement Layers 405 and 406. Furthermore, Scene 401 refers to other Scenes 401 that are for untimed media. Scene 401 also refers to Scene 407 that is for a timed media scene. Lists 406 identify unique assets associated with a particular scene that have not been previously used in higher order (e.g., parent) scenes. FIG. 5 illustrates a sample embodiment of a Natural Media Synthesis Process 500 to synthesize an ingest format from natural content. Camera unit 501 uses a single camera lens to capture a scene of a person. Camera unit 502 captures a scene with five diverging fields of view by mounting five camera lenses around a ring-shaped object. The arrangement in 502 is an exemplary arrangement commonly used to capture omnidirectional content for VR applications. Camera unit 503 captures a scene with seven converging fields of view by mounting seven camera lenses on the inner diameter portion of a sphere. The arrangement 503 is an exemplary arrangement commonly used to capture light fields for light field or holographic immersive displays. Natural image content 509 is provided as input to Synthesis Process 504 that may optionally employ a Neural Network Training Process 505 using a collection of Training Images 506 to produce an optional Capture Neural Network Model 508. Another process commonly used in lieu of training process 505 is Photogrammetry. If model 508 is created during process 500 depicted in FIG. 5, then model 508 becomes one of the assets in the Ingest Format 510 for the natural content. Annotation Process 507 may optionally be performed to annotate scene-based media with IMS metadata. Exemplary embodiments of the Ingest Format 510 include MPI and MSI.

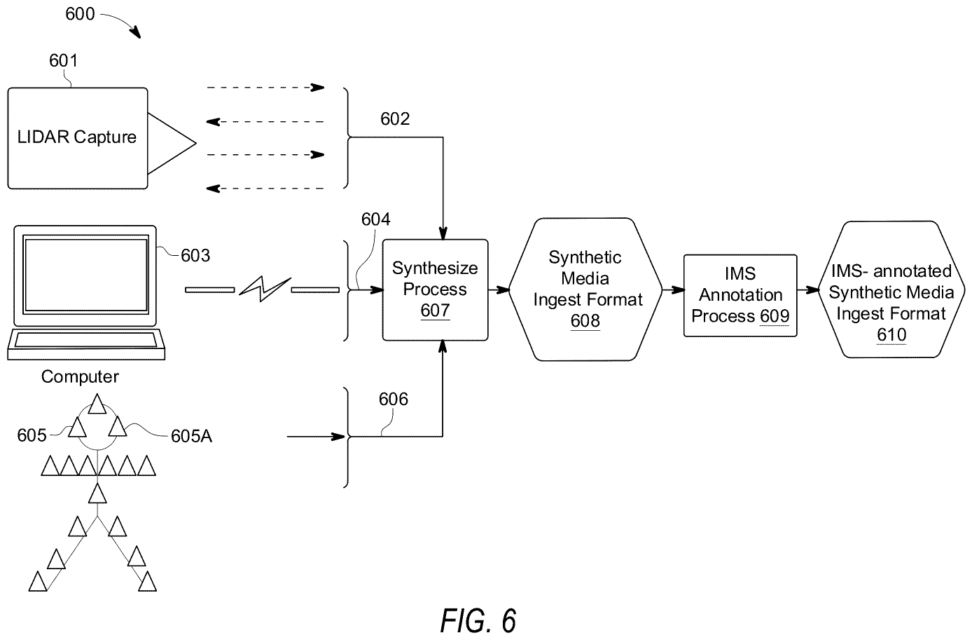

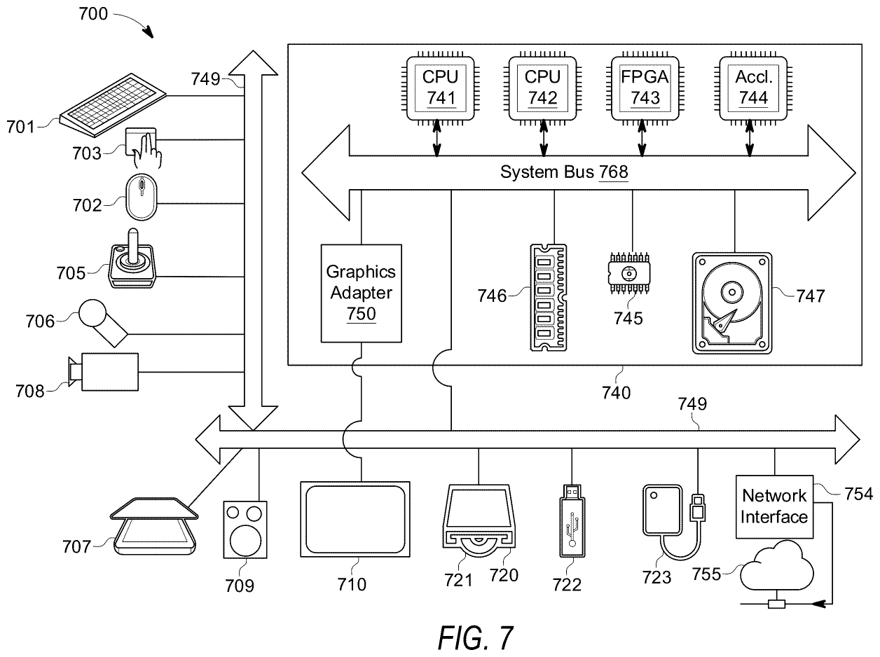

FIG. 6 illustrates an embodiment of a Synthetic Media Ingest Creation Process 600 to create an ingest format for synthetic media, e.g., computer-generated imagery. LIDAR Camera 601 captures Point Clouds 602 of scene. CGI tools, 3D modelling tools, or another animation processes to create synthetic content are employed on Computer 603 to create 604 CGI Assets over a network. Motion Capture Suit with Sensors 605A is worn on Actor 605 to capture a digital recording of the motion for actor 605 to produce animated MoCap Data 606. Data 602, 604, and 606 are provided as input to Synthesis Process 607 which outputs Synthetic Media Ingest Format 608. Format 608 may then be input into an optional IMS Annotation Process 609 whose output is IMS-annotated Synthetic Media Ingest Format 610. The techniques for representing and streaming heterogeneous immersive media described above, can be implemented as computer software using computer-readable instructions and physically stored in one or more computer-readable media. For example, FIG. 7 depicts a computer system 700 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like. The instructions can be executed on various types of computers or components thereof, including, for example, personal computers, tablet computers, servers, smartphones, gaming devices, internet of things devices, and the like. The components shown in FIG. 7 for computer system 700 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input. The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video). Input human interface devices may include one or more of (only one of each depicted): keyboard 701, mouse 702, trackpad 703, touch screen 710, data-glove, joystick 705, microphone 706, scanner 707, and camera 708.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, data-glove, or joystick 705, but there can also be tactile feedback devices that do not serve as input devices), audio output devices (such as: speakers 709, headphones), visual output devices (such as screens 710 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses, holographic displays and smoke tanks), and printers. Computer system 700 can also include human accessible storage devices and their associated media such as optical media including CD/DVD ROM/RW 720 with CD/DVD or the like media 721, thumb-drive 722, removable hard drive or solid state drive 723, legacy magnetic media such as tape and floppy disc, specialized ROM/ASIC/PLD based devices such as security dongles, and the like. Those skilled in the art should also understand that term “computer readable media” as used in connection with the presently disclosed subject matter does not encompass transmission media, carrier waves, or other transitory signals.

Computer system 700 can also include interface to one or more communication networks. Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (749) (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks, computer system 700 can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above. Aforementioned human interface devices, human-accessible storage devices, and network interfaces can be attached to a core 740 of the computer system 700. The core 740 can include one or more Central Processing Units (CPU) 741, Graphics Processing Units (GPU) 742, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 can be accessible in the form of one or more physical plugs to enable extensions by additional CPUs, GPU, and the like. The peripheral devices can be attached either directly to the core's system bus 748, or through a peripheral bus 749. Architectures for a peripheral bus include PCI, USB, and the like. CPUs 741, GPUs 742, FPGAS 743, and accelerators 744 can execute certain instructions that, in combination, can make up the aforementioned computer code. That computer code can be stored in ROM 745 or RAM 746. Transitional data can be also be stored in RAM 746, whereas permanent data can be stored for example, in the internal mass storage 747. Fast storage and retrieve to any of the memory devices can be enabled through the use of cache memory, that can be closely associated with one or more CPU 741, GPU 742, mass storage 747, ROM 745, RAM 746, and the like. The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 700, and specifically the core 740 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 740 that are of non-transitory nature, such as core-internal mass storage 747 or ROM 745. The software implementing various embodiments of the present disclosure can be stored in such devices and executed by core 740. A computer-readable medium can include one or more memory devices or chips, according to particular needs. The software can cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system can provide functionality as a result of logic hardwired or otherwise embodied in a circuit (for example: accelerator 744), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

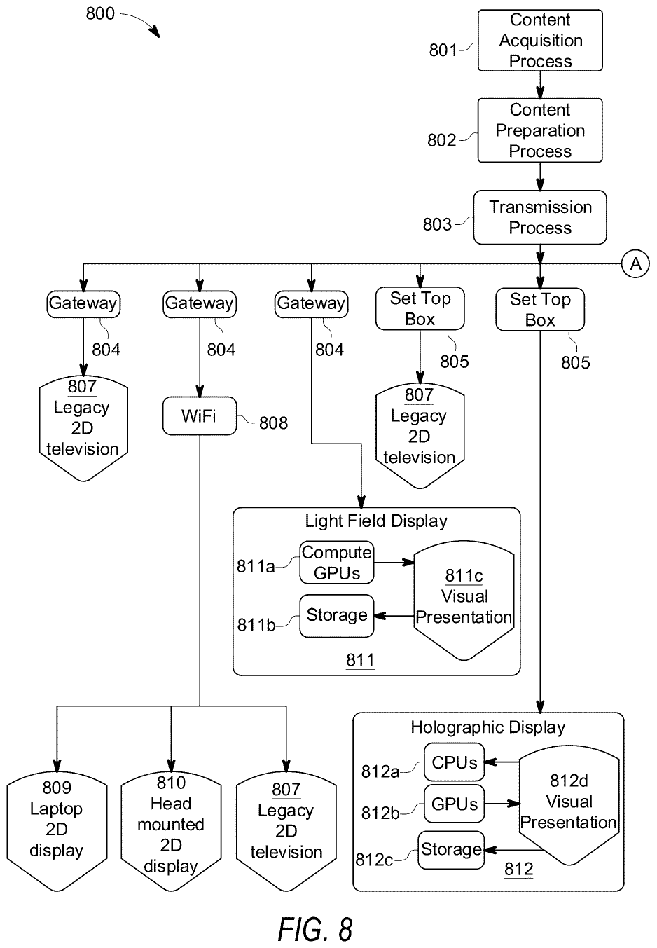

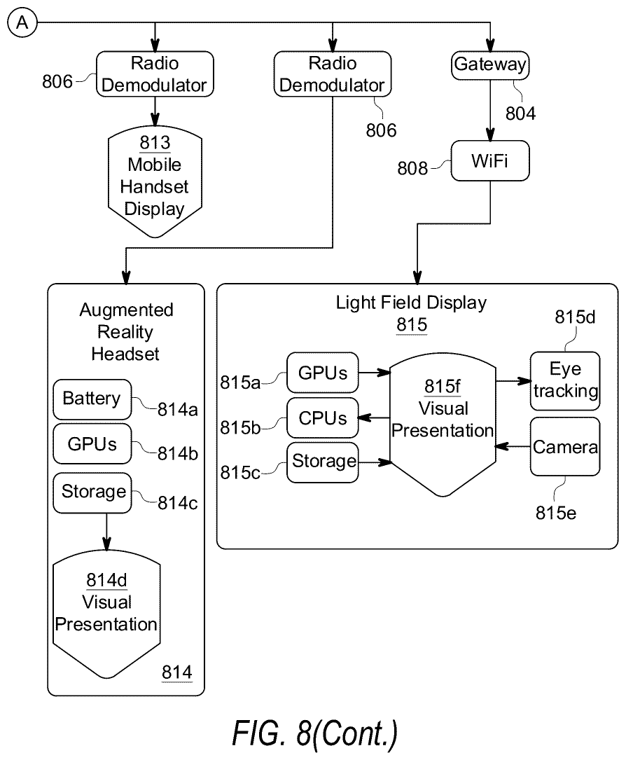

FIG. 8 (which includes FIG. 8 connected to FIG. 8(Cont.) by connector A) illustrates an exemplary Network Media Distribution System 800 that supports a variety of legacy and heterogenous immersive-media capable displays as client end-points. Content Acquisition Process 801 captures or creates the media using example embodiments in FIG. 6 or FIG. 5. Ingest formats are created in Content Preparation Process 802 and then are transmitted to network media distribution system using Transmission Process 803. Gateways 804 may serve customer premise equipment to provide network access to various client end-points for the network. Set Top Boxes 805 may also serve as customer premise equipment to provide access to aggregated content by the network service provider. Radio Demodulators 806 may serve as mobile network access points for mobile devices, e.g. as shown with Mobile Handset and Display 813. In this particular embodiment of system 800, Legacy 2D Televisions 807 are shown to be directly connected to gateways 804 Set Top Box 805, or WiFi Router 808. A computer laptop with a legacy 2D display 809 is illustrated as a client end-point connected to WiFi Router 808. A Head Mounted 2D (raster-based) Display 810 is also connected to router 808. A Lenticular Light Field Display 811 is shown connected to a gateway 804. Display 811 is comprised of local Compute GPUs 811A, Storage Device 811B, and a Visual Presentation Unit 811C that creates multiple views using a ray-based lenticular optical technology. A Holographic Display 812 is shown connected to a set top box 805. Display 812 is comprised of local Compute CPUs 812A, GPUs 812B, Storage Device 812C, and a Fresnal pattern, wave-based holographic Visualization Unit 812D. An Augmented Reality Headset 814 is shown connected to radio demodulator 806. Headset 814 is comprised of GPU 814A, Storage Device 814B, Battery 814C, and volumetric Visual Presentation Component 814D. Dense Light Field Display 815 is shown as connected to a WiFi router 808. The Display 815 is comprised of multiple GPUs 815A, CPUs 815B, Storage Device 815C, Eye Tracking Device 815D, Camera 815E, and a dense ray-based light field panel 815F.

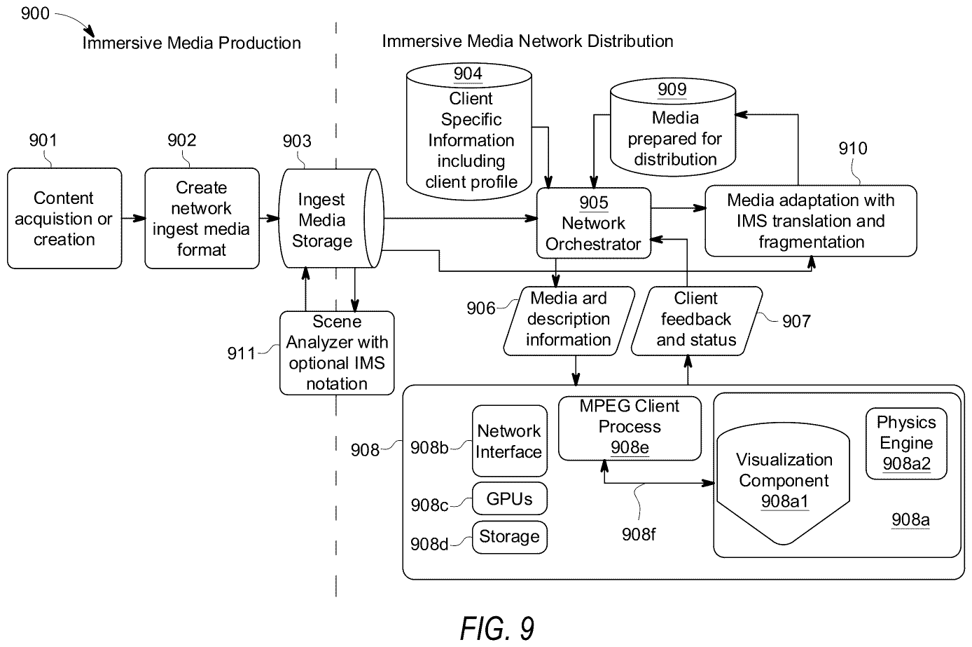

FIG. 9 illustrates an embodiment of an Immersive Media Distribution with Scene Analyzer for default viewport Process 900 that is capable of serving legacy and heterogenous immersive media-capable displays as previously depicted in FIG. 8. Content is either created or acquired in Process 901, which is further embodied in FIG. 5 and FIG. 6 for natural and CGI content respectively. Content 901 is then converted into an ingest format using the Create Network Ingest Format Process 902. Process 902 is likewise further embodied in FIG. 5 and FIG. 6 for natural and CGI content respectively. The ingest media is optionally annotated with IMS metadata by Scene Analyzer with Optional IMS Notation 911. The ingest media format is transmitted to the network and stored on Storage Device 903. Optionally, the Storage Device may reside in the immersive media content producer's network, and accessed remotely by the Immersive Media Network Distribution Process (not numbered) as depicted by the dashed line that bisects 903. Client and application specific information is optionally available on a remote Storage Device 904, which may optionally exist remotely in an alternate “cloud” network.

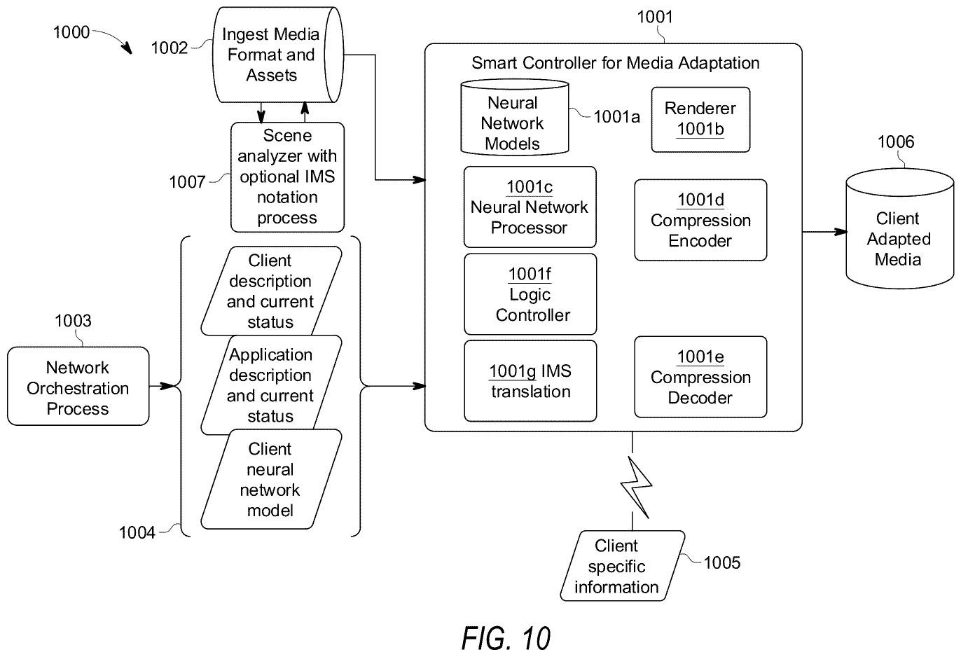

As depicted in FIG. 9, a Network Orchestration Process 905 serves as the primary source and sink of information to execute the major tasks of the distribution network. In this particular embodiment, Process 905 may be implemented in unified format with other components of the network. Nevertheless the tasks depicted by Process 905 in FIG. 9 form essential elements of the disclosed subject matter. Orchestration Process 905 may further employ a bi-directional message protocol with the client to facilitate all processing and distribution of the media in accordance with the characteristics of the client. Furthermore, the bi-directional protocol may be implemented across different delivery channels, i.e., a control plane channel and a data plane channel. Process 905 receives information about the features and attributes of Client 908, and furthermore collects requirements regarding the application currently running on 908. This information may be obtained from Device 904, or in an alternate embodiment, may be obtained by directly querying the client 908. In the case of a direct query to client 908, a bi-directional protocol (not shown in FIG. 9) is assumed to be present and operational so that the client may communicate directly to the Orchestration Process 905. Orchestration Process 905 also initiates and communicates with Media Adaptation and Fragmentation Process 910 which is described in FIG. 10. As ingest media is adapted and fragmented by Process 910, the media is optionally transferred to an intermedia storage device depicted as the Media Prepared for Distribution Storage Device 909. As the distribution media is prepared and stored in device 909, Orchestration Process 905 ensures that Immersive Client 908, via its Network Interface 908B, either receives the distribution media and corresponding descriptive information 906 either through a “push” request, or Client 908 itself may initiate a “pull” request of the media 906 from Storage Device 909. Orchestration Process 905 may employ a bi-directional message interface (not shown in FIG. 9) to perform the “push” request or to initiate a “pull” request by the Client 908. Immersive Client 908 may optionally employ GPUs (or CPUs not shown) 908C. The Distribution Format of the media is stored in Client 908's Storage Device or Storage Cache 908D. Finally, Client 908 visually presents the media via its Visualization Component 908A. Throughout the process of streaming the immersive media to Client 908, the Orchestration Process 905 will monitor the status of the Client's progress via Client Progress and Status Feedback Channel 907. The monitoring of status may be performed by means of a bi-directional communication message interface (not shown in FIG. 9).

FIG. 10 depicts a particular embodiment of a Scene Analyzer for Media Adaptation Process 1000 so that the ingested source media may be appropriately adapted to match the requirements of the Client 908. Media Adaptation Process 1001 is comprised of multiple components that facilitate the adaptation of the ingest media into an appropriate distribution format for Client 908. These components should be regarded as exemplary. In FIG. 10, Adaptation Process 1001 receives input Network Status 1005 to track the current traffic load on the network; Client 908 information including Attributes and Features Description, Application Features and Description as well as Application Current Status, and a Client Neural Network Model (if available) to aid in mapping the geometry of the client's frustum to the interpolation capabilities of the ingest immersive media. Such information may be obtained by means of a bi-directional message interface. Adaptation Process 1001 ensures that the adapted output, as it is created, is stored into a Client-Adapted Media Storage Device 1006. Scene Analyzer with Optional IMS Notation Process 1007 is depicted in FIG. 10 as an optional process that may be executed a prioi or as part of the network automated process for the distribution of the media.

Adaptation Process 1001 is controlled by Logic Controller 1001F. Adaptation Process 1001 also employs a Renderer 1001B or a Neural Network Processor 1001C to adapt the specific ingest source media to a format that is suitable for the client. Neural Network Processor 1001C uses Neural Network Models in 1001A. Examples of such a Neural Network Processor 1001C include the Deepview neural network model generator as described in MPI and MSI. If the media is in a 2D format, but the client must have a 3D format, then the Neural Network Processor 1001C can invoke a process to use highly correlated images from a 2D video signal to derive a volumetric representation of the scene depicted in the video. An example of a suitable Renderer 1001B could be a modified version of the OTOY Octane renderer which would be modified to interact directly with the Adaptation Process 1001. Adaptation Process 1001 may optionally employ Media Compressors 1001D and Media Decompressors 1001E depending on the need for these tools with respect to the format of the ingest media and the format required by Client 908.

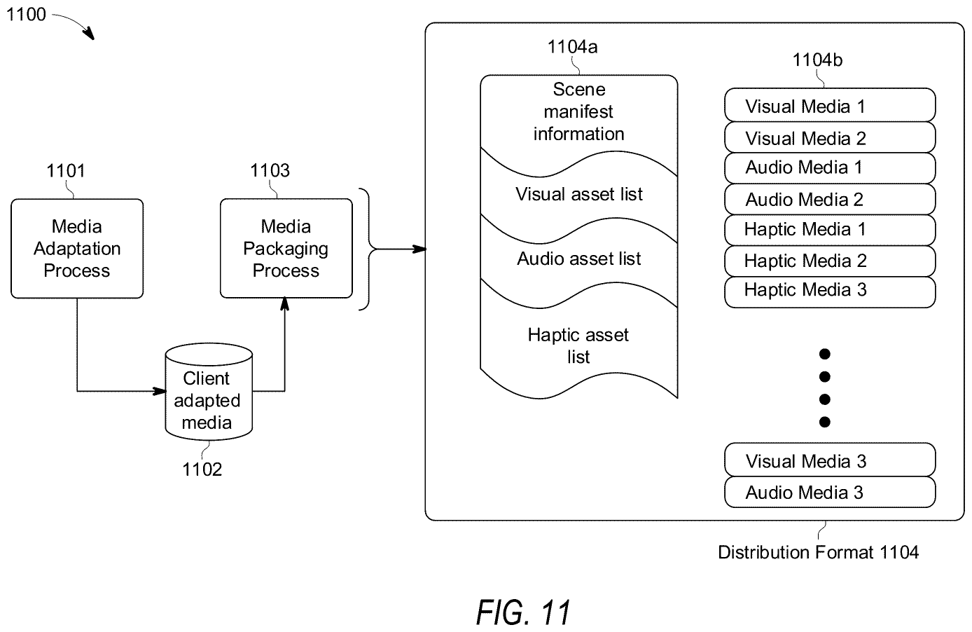

FIG. 11 depicts a Distribution Format Creation Process 1100. Adapted Media Packaging Process 1103 packages media from Media Adaptation Process 1101 (depicted as Process 1000 in FIG. 10) now residing on Client Adapted Media Storage Device 1102. The Packaging Process 1103 formats the Adapted Media from Process 1101 into a robust Distribution Format 1104, for example, the exemplary formats shown in FIG. 3 or FIG. 4. Manifest Information 1104A provides Client 908 with a List of Scene Data Assets 1104B that it can expect to receive. List 1104B depicts a list of Visual Assets, Audio Assets, and Haptic Assets, each with their corresponding metadata.

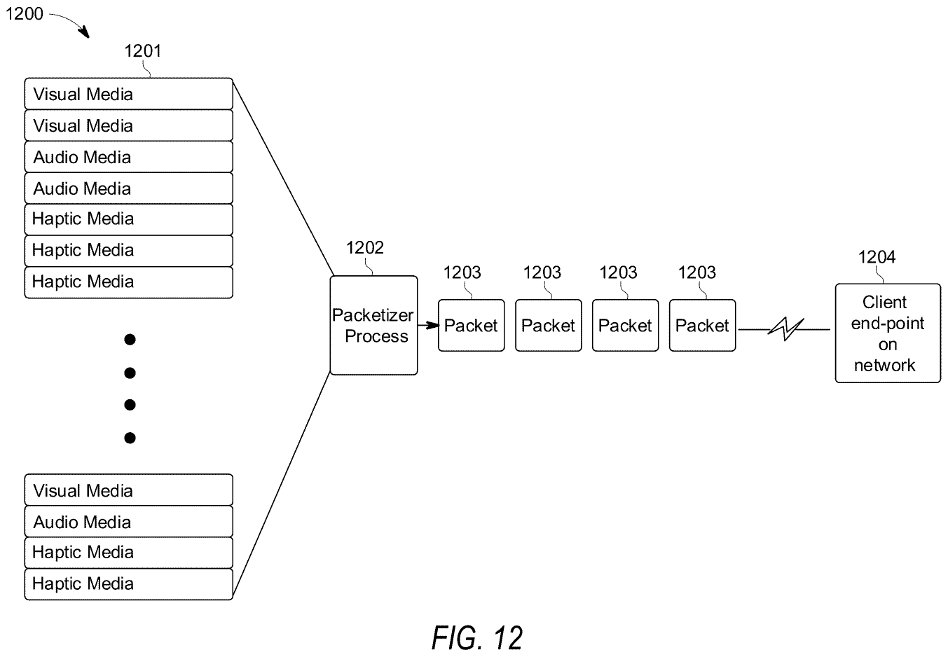

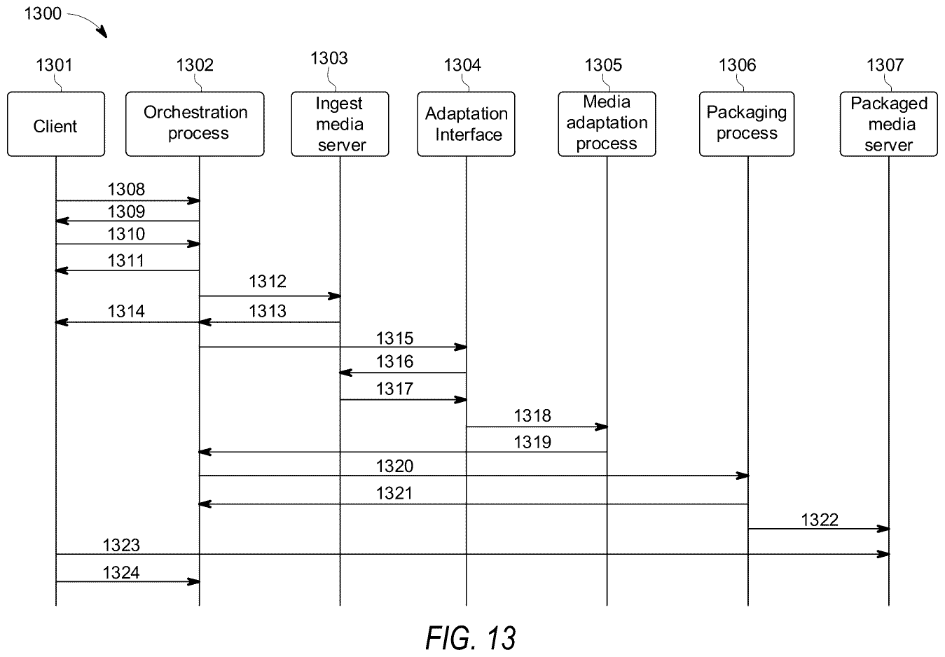

FIG. 12 depicts a Packetizer Process System 1200. Packetizer Process 1202 separates the adapted media 1201 into individual Packets 1203 suitable for streaming to Client 908. The components and communications shown in FIG. 13 for Sequence Diagram 1300 are explained as follows: Client end-point 1301 initiates a Media Request 1308 to Network Distribution Interface 1302. The request 1308 includes information to identify the media that is requested by the client, either by URN or other standard nomenclature. The Network Distribution Interface (also known as Client 1302 responds to request 1308 with Profiles Request 1309, which requests that client 1301 provide information about its currently available resources (including compute, storage, percent battery charged, and other information to characterize the current operating status of the client). Profiles Request 1309 also requests that the client provide one or more neural network models that can be used by the network for neural network inferencing to extract or interpolate the correct media views to match the features of the client's presentation system, if such models are available at the client. Response 1311 from client 1301 to interface 1302 provides a client token, application token, and one or more neural network model tokens (if such neural network model tokens are available at the client). The interface 1302 then provides client 1301 with a Session ID token 1311. Interface 1302 then requests Ingest Media Server 1303 with Ingest Media Request 1312, which includes the URN or other standard name for the media identified in request 1308. Server 1303 replies to request 1312 with response 1313 which includes an ingest media token. Interface 1302 then provides the media token from response 1313 in a call 1314 to client 1301. Interface 1302 then initiates the adaptation process for the requested media in 1308 by providing the Adaptation Interface 1304 with the ingest media token, client token, application token, and neural network model tokens. Interface 1304 requests access to the ingest media by providing server 1303 with the ingest media token at call 1316 to request access to the ingest media assets. Server 1303 responds to request 1316 with an ingest media access token in response 1317 to interface 1304. Interface 1304 then requests that Media Adaptation Process 1305 adapt the ingest media located at the ingest media access token for the client, application, and neural network inference models corresponding to the session ID token created at 1313. Request 1318 from interface 1304 to process 1305 contains the required tokens and session ID. Process 1305 provides interface 1302 with adapted media access token and session ID in update 1319. Interface 1302 provides Packaging Process 1306 with adapted media access token and session ID in interface call 1320. Packaging process 1306 provides response 1321 to interface 1302 with the Packaged Media Access Token and Session ID in response 1321. Process 1306 provides packaged assets, URNs, and the Packaged Media Access Token for the Session ID to the Packaged Media Server 1307 in response 1322. Client 1301 executes Request 1323 to initiate the streaming of media assets corresponding to the Packaged Media Access Token received in message 1321. The client 1301 executes other requests and provides status updates in message 1324 to the interface 1302.

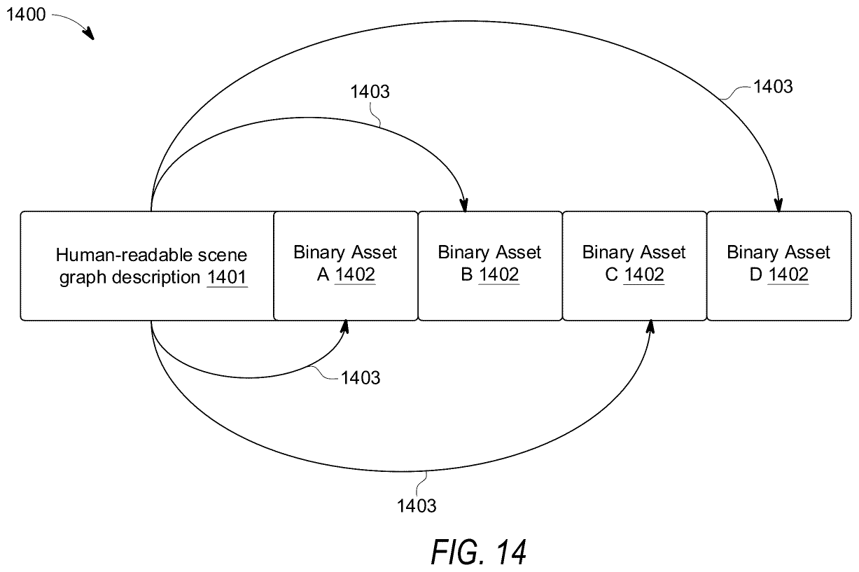

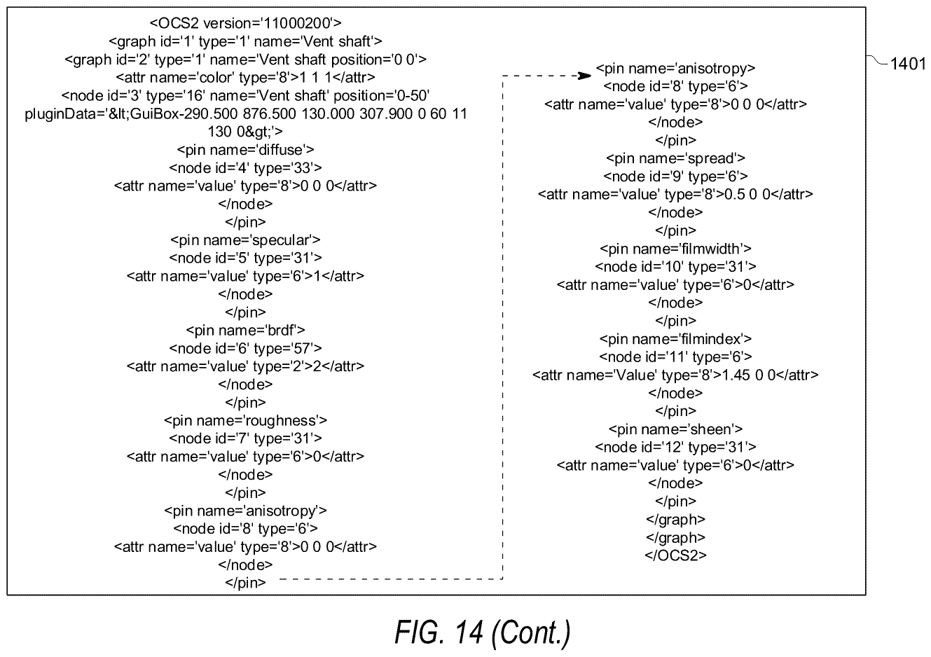

FIG. 14 (which includes FIG. 14 and FIG. 14(Cont.)) depicts an exemplary scene graph architecture 1400. Human-readable scene graph description 1401 serves as the portion of the scene graph where spatial, logical, physical, and temporal aspects of the attached assets are stored. Description 1401 also contains references to binary assets that further comprise the scene. Associated with the Description 1401 are Binary Assets 1402. FIG. 14 illustrates that there are four binary assets for the exemplary graph including: Binary Asset A 1402, Binary Asset B 1402, Binary Asset C 1402, and Binary Asset D 1402. References 1403 from Description 1401 are also illustrated as: Reference 1403 to Binary Asset A, Reference 1403 to Binary Asset B, Reference 1403 to Binary Asset C, and Reference 1403 to Binary Asset D.

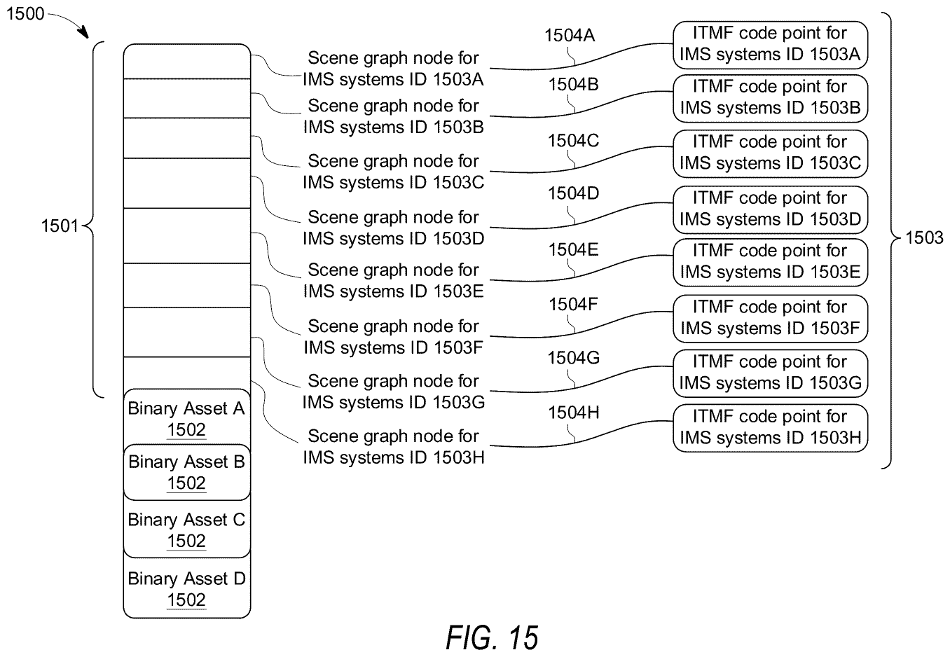

FIG. 15 provides an exemplary annotated scene graph architecture 1500 in which the IMS systems metadata 1503? (where ? represents a character in the figure) is written directly into the human-readable portion 1501 of the scene graph architecture 1500. In this example, the IMS systems metadata 1503? is comprised of multiple systems of metadata: 1503A, 1503B, 1503C, 1503D, 1503E, 1503F, 1503G, and 1503H where each system is associated with its own unique IMS systems identifier code point corresponding to the ? depicted for items 1503 in the figure. Mappings 1504? (where ? represents a character in the figure) further provide the additional information of a unique ITMF code point (obtained from the ITMF Suite of Specifications) that fully or partially characterizes the information contained in each section of human-readable portion 1501, such mappings 1504? depicted in the FIG. including: 1504A, 1504B, 1504C, 1504D, 1504E, 1504F, 1504G, and 1504H. The IMS metadata written into the human-readable portion 1501 is comprised of the information depicted in mappings 1504? as described above. Scene graph architecture 1500 is further comprised of scene assets 1502.

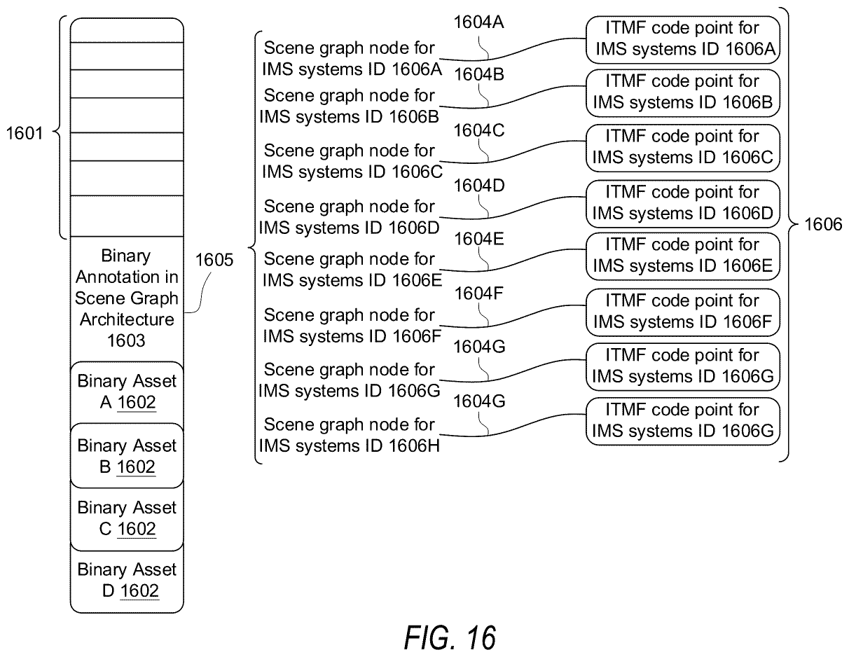

FIG. 16 provides an exemplary annotated scene graph architecture 1600 in which the IMS systems metadata 1606? (where ? represents a character in the figure) is written directly into a binary portion 1603 of the architecture instead of or in addition to the storage of such metadata in the human-readable portion 1601 (as depicted in FIG. 15) of the scene graph architecture 1600. In this example, the IMS systems metadata 1606? is comprised of multiple systems of metadata: 1606A, 1606B, 1606C, 1606D, 1606E, 1606F, 1606G, and 1606H where each system is associated with its own unique IMS systems identifier code point corresponding to the ? depicted for items 1606 in the figure. Mappings 1604? (where ? represents a character in the figure) further provide the additional information of a unique ITMF code point (obtained from the ITMF Suite of Specifications) that fully or partially characterizes the information contained in human-readable portion 1601, such mappings 1604? depicted in the FIG. including: 1604A, 1604B, 1604C, 1604D, 1604E, 1604F, 1604G, and 1604H. The IMS metadata written into binary portion 1603 is comprised of the information depicted in mappings 1604? as described above. Scene graph architecture 1600 is further comprised of scene assets 1602.

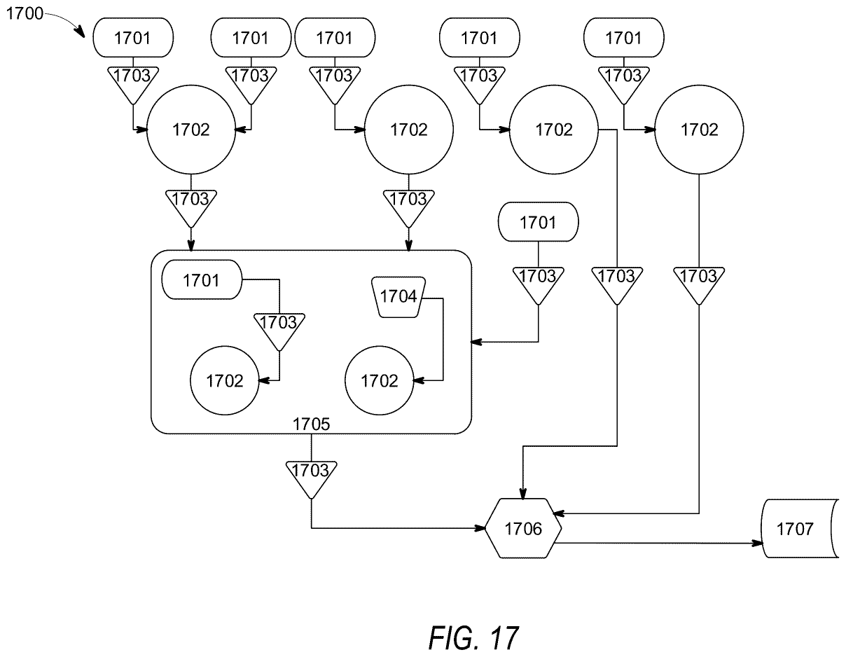

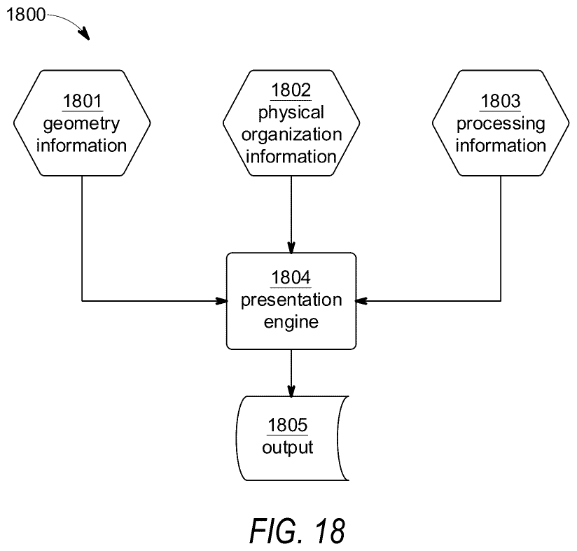

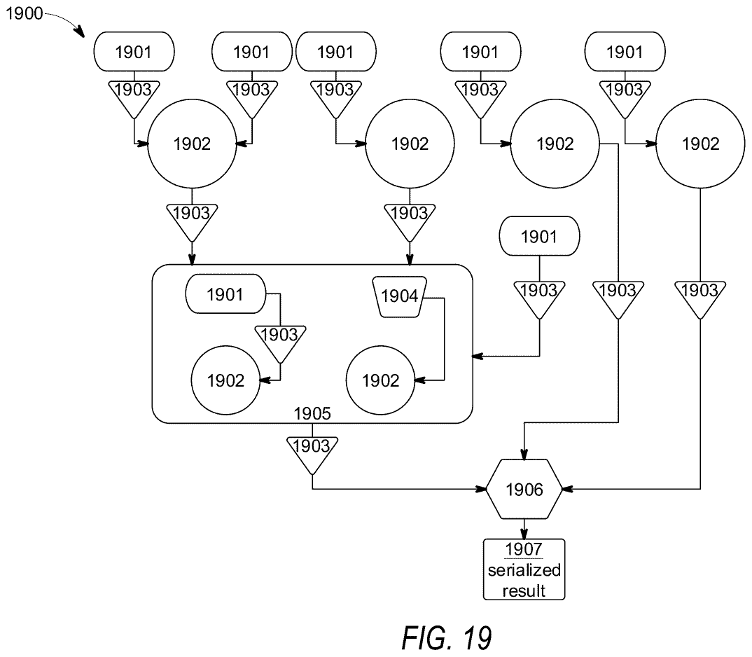

FIG. 17 depicts the organization of the “Independent Mapping Space” according to one or more embodiments herein and may be adopted to or currently described in ISO/IEC 23090 Part 28. Items labeled as “1701” represent data values (e.g., numeric values, enumerators, geospatial coordinates), items labeled as “1702” represent scene features such as lighting, cameras, materials, textures, geometry, environments, object layers, surfaces, arbitrary output variables, arbitrary output variable compositors, or transformations, items labelled as “1703” represent input or output connectors between other items (e.g., such as those labelled as “1702”), items labelled as “1704” represent immutable attributes that should not be changed during a serialization process, the item labelled as “1705” represents a group of other items, the items labelled as “1706” represents rendering instructions (which may also be considered as process-related instructions) or parameters, and the item labelled as “1707” represents the rendered or presented output. In this example, it is clear that the architecture, especially for items labelled as “1702” does not distinguish between items that are used during the rendering process (such as cameras and lighting) and items that describe the geometric objects in the scene (such as materials, textures, geometric meshes, and more). FIG. 18 depicts a “distilled” version of the information represented in FIG. 17 in which the scene information is organized as 1801 geometry information, 1802 physical organization information (to describe how the media is organized, accessed, and written in files, buffers, or other containers), and 1803 processing information related to instructions or parameters for the rendering or presentation of the media. Information 1801, 1802, and 1803 are provided to presentation engine 1804, which renders or otherwise presents the scene media. Output 1805 is provided as output from engine 1804. FIG. 19 illustrates the organization as shown in FIG. 17, but with the specific difference that the same representation can be used to organize a particular serialized result 1901 for either geometric information as depicted in 1801, physical information as depicted in 1802, and processing information as depicted in 1803 according to one or more embodiments herein.

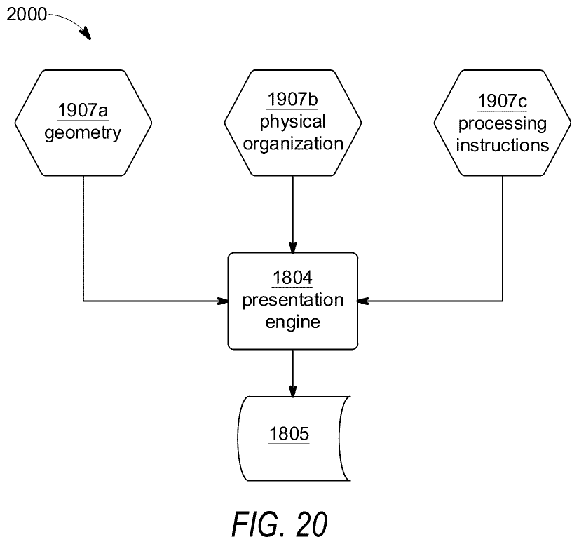

FIG. 20 illustrates that representation result 1901 can be used to represent either geometric information as depicted in 1901A, physical information as depicted in 1901B, or processing information, as depicted in 1901C. Each collection of information (1901A, 1901B, and 1901C) is provided to presentation engine 1804 to produce output 1805. Therefore, as described above, during the development of Independent Mapping Space, it has become clear that the architecture as presented in the CD ballot of Part 28 needs to be improved to better handle the goal of creating an interchangeable representation for many scene-based formats. And embodiments herein provide an update to the IMS architecture in Part 28, with the suggestion that this update be adopted into Part 28 prior to the planned DIS ballot, i.e., as an output of MPEG 147. A text of Part 28 may include a relatively “flat” description of IMS systems covering multiple aspects regarding a representation of scene-based media. In all, there are 21 systems among which it can be observed that some of the systems are related to each other, and others not. For example, the Animation, Render Instruction, Render Arbitrary Output Variables, Arbitrary Output Variables Compositor, Lighting, Camera, Kernel, and Open Color IO systems each relate to specific actions that a presentation engine should perform during the serialization and or rendering of the scene. Likewise, many of the systems relate to describing logical relationships and the geometric organization amongst objects within the scene. That is, the materials, scene object, connection pins, graph type, geometry, and others in Table 1 relate to describing the organization and attributes of the geometry of the scene (including relationships between scene objects).

Further study according to embodiments herein of the systems indicated that the buffer system stands out as the only system that fits into neither of the categories thus far identified, i.e., for rendering actions and instructions and logical geometric organization. The buffer system is unique in that it attempts to address the physical aspects of how the binary scene media is stored, accessed, read, or written. The ITMF technology, upon which the IMS is based (and likewise inspired), includes an entire separate specification, i.e., the ITMF Container Specification, to describe the physical aspects of how the ITMF media is stored, how it is to be read, and how it is to be decrypted, along with many other properties of the physical storage of the media. And according to embodiments herein, there is provided that like the ITMF, the IMS should include metadata to describe how the media should be physically stored, accessed, and otherwise managed by a presentation engine. More specifically, given that there are already two pronounced categories of the existing 21 systems that currently comprise the IMS, a third category should be added and the number of systems expanded to cover the physical aspects of the media. With the emergence of these three high level categories, it is natural to reconfigure the existing IMS architecture to include: i. rendering actions or “instructions” specific to how the renderer or a presentation engine should serialize and present the media, ii. information regarding the geometry of the scene, including relationships between objects, and descriptions of individual objects and the scene background, and iii. information about how the media is physically stored

The following systems are identified as relevant to the real-time processing that a renderer or presentation engine performs: Animation, Render Instruction, Render Arbitrary Output Variables, Arbitrary Output Variables Compositor, Lighting, Camera, Kernel, Open Color IO, and Object Layer. The following systems are identified as relevant to the description of geometry and relationships between scene objects: System value, Material, Texture, Geometry, Surface, Transform, Graph, Connection pins, Data attributes, Scene object, and Environment.

In addition to the Buffer system, the following new systems are proposed to be added to the IMS to satisfy the need to describe aspects of how the media is stored, read, written, and accessed: a global properties system to describe the entire physical storage representation of the scene media; a local properties system to describe local aspects of the storage representation of the scene media; a physical stream system to signal the presence of a stream of bytes and its properties corresponding to at least one physical element of the scene; a stream chunk system to signal the presence of a “chunk” of bytes (a unique physical boundary consisting of a start and stop indicators) and its properties corresponding to a physical stream; a stream indices system to signal random access points of a physical stream; a directory system to provide a list of storage properties and other metadata for at least one stream; a signature system to provide encryption information if the scene is encrypted; a scene footer system to provide information related to the end of the scene.

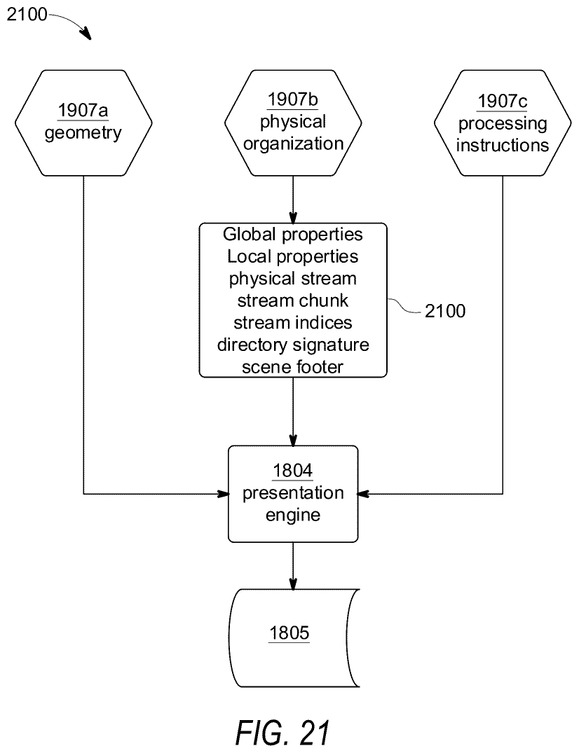

Further, FIG. 21 illustrates physical storage features 2100 depicted in the same diagram from FIG. 20. Features 2100 include: global properties to signal properties that may be applied to the entire physical storage representation of the scene media; local properties that may be applied only to local aspects of the storage representation of the scene media; physical stream that may indicate the presence of a stream of bytes corresponding to one physical element of the scene; stream chunk that may indicate the presence of a “chunk” of bytes (a unique physical boundary consisting of a start and stop indicators) corresponding to a physical stream; stream indices that may signal random access points of a physical stream; directory that may indicate provide a list of properties and other metadata for each stream; signature that may provide encryption information if the scene is encrypted; scene footer that may provide information related to the end of the scene.

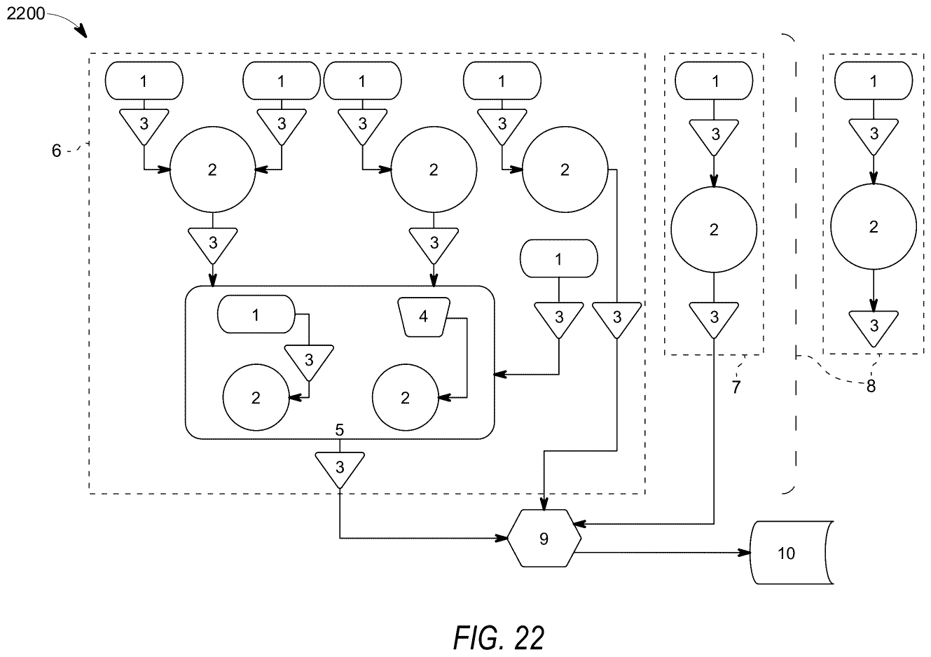

FIG. 22 illustrates an example 2200 of a canonical representation of IMS geometric objects within the scene according to one or more embodiments herein of which element 1 represents Canonical IMS values (e.g., integer, enumeration, float, . . . ), element 2 represents IMS systems for logical organization, physical organization, and processing directions, element 3 represents input or output pin, element 4 represents attribute, element 5 represents node graph, element 6 represents logical organization of geometry, element 7 represents processing directions, element 8 represents physical organization of scene graph, element 9 represents a representation engine (not a system in the IMS), and element 10 represents a rendered output (not a system in the IMS). An IMS value (item 1) shall represent an input value from the value node system to any one of the other IMS systems (item 2) including systems designated for logical organization, physical organization, and processing directions for the scene. Input or output relationships between any of the system nodes shall be established with IMS data pins (element 3). Attributes shall represent other IMS system nodes or value nodes that are considered to be immutable (not changeable by rendering processes). A collection of system nodes is designated to describe the logical organization of the geometry (element 6); processing directions (element 7); and physical organization (element 8) in the scene. A node graph (element 5) shall represent a collection of other IMS system nodes that may also include attributes or render-specific metadata (not in scope of this Specification). Inputs to a presentation engine (element 9) include information about the logical organization, processing directions, and physical organization (not shown in the FIG.) to produce a rendered output (element 10). IMS systems used to describe the logical organization component of a scene are identified by a label with a prefix of ‘ims.logical’ according to example embodiments. IMS systems used to describe the physical organization component of a scene are identified by a label with a prefix of ‘ims.physical’. IMS systems used to describe the processing directions component of a scene are identified by a label with a prefix of ‘ims.process’.

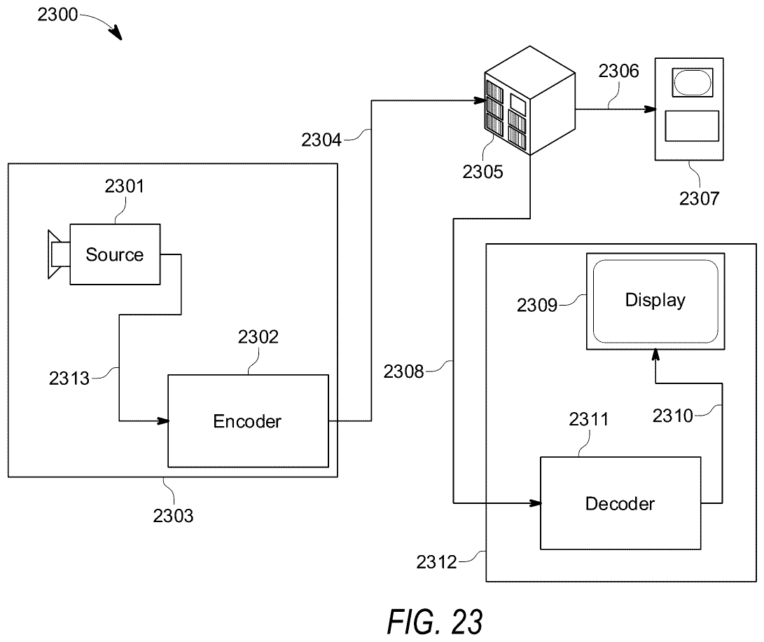

FIG. 23 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 2303 that can include a video source 2301, for example a digital camera, creating, for example, an uncompressed video sample stream 2313. That sample stream 2313 may be emphasized as a high data volume when compared to encoded video bitstreams and can be processed by an encoder 2302 coupled to the camera 2301. The encoder 2302 can include hardware, software, or a combination thereof to enable or implement aspects of the disclosed subject matter as described in more detail below. The encoded video bitstream 2304, which may be emphasized as a lower data volume when compared to the sample stream, can be stored on a streaming server 2305 for future use. One or more streaming clients 2312 and 2307 can access the streaming server 2305 to retrieve copies 2308 and 2306 of the encoded video bitstream 2304. A client 2312 can include a video decoder 2311 which decodes the incoming copy of the encoded video bitstream 208 and creates an outgoing video sample stream 2310 that can be rendered on a display 2309 or other rendering device. In some streaming systems, the video bitstreams 2304, 2306 and 2308 can be encoded according to certain video coding/compression standards.

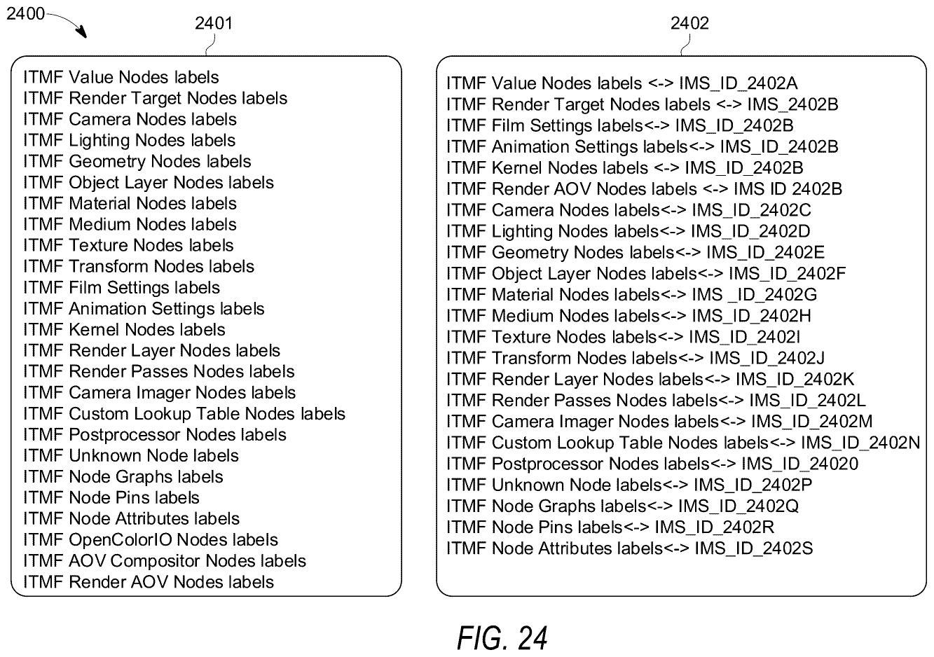

FIG. 24 depicts an example mapping 2400 of IMS subsystem identifiers 2402? (where ? represents a character in the figure) to one or more unique labels 2401 from the ITMF Suite of Specifications version 2.0. IMS subsystems identifiers 2402? include: IMS_ID_2402A, IMS_ID_2402B, IMS_ID_2402C, IMS_ID_2402D, IMS_ID_2402E, IMS_ID_2402F, IMS_ID_2402G, IMS_ID_2402H, IMS_ID_24021, IMS_ID_2402J, IMS_ID_2402K, IMS_ID_2402L, IMS_ID_2402M, IMS_ID_2402N, IMS_ID_24020, IMS_ID_2402P, IMS_ID_2402Q, IMS_ID_2402R, and IMS_ID_2402S. Mapping 2400 illustrates (for exemplary purposes) that: IMS_ID_2402A is mapped to ITMF labels for Value Nodes; IMS_ID_2402B is mapped to ITMF labels for Render Target Nodes, Film Settings Nodes, Animation Settings Nodes, Kernal Nodes, and Render AOV Nodes; IMS_ID_2402C is mapped to ITMF labels for Render Target Nodes; IMS_ID_2402D is mapped to ITMF labels for Camera Nodes; IMS_ID_2402E is mapped to ITMF labels for Lighting Nodes; IMS_ID_2402F is mapped to ITMF labels for Object Layer Nodes; IMS_ID_2402G is mapped to ITMF labels for Material Nodes; IMS_ID_2402H is mapped to ITMF labels for Medium Nodes; IMS_ID_24021 is mapped to ITMF labels for Texture Nodes; IMS_ID_2402J is mapped to ITMF labels for Transform Nodes; IMS_ID_2402K is mapped to ITMF labels for Render Layer Nodes; IMS_ID_2402L is mapped to ITMF labels for Render Passes Nodes; IMS_ID_2402M is mapped to ITMF labels for Camera Imager Nodes; IMS_ID_2402N is mapped to ITMF labels for Custom Lookup Table Nodes; IMS_ID_24020 is mapped to ITMF labels for Postprocessor Nodes; IMS_ID_2402P is mapped to ITMF labels for Unknown Nodes; IMS_ID_2402Q is mapped to ITMF labels for Node Graph Nodes; IMS_ID_2402R is mapped to ITMF labels for Node Pins; and IMS_ID_2402S is mapped to ITMF labels for Node Attributes.

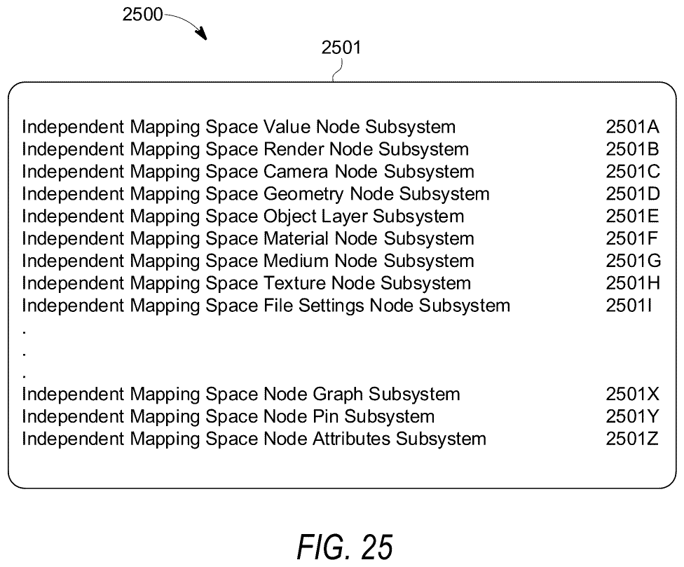

FIG. 25 depicts an exemplary system structure 2500 to organize the IMS subsystems described in the disclosed subject matter. In this example, the following IMS subsystems are defined: 2501A is the Independent Mapping Space Value Node Subsystem; 2501B is the Independent Mapping Space Render Node Subsystem; 2501C is the Independent Mapping Space Camera Node Subsystem; 2501D is the Independent Mapping Space Geometry Node Subsystem; 2501E is the Independent Mapping Space Object Layer Subsystem; 2501F is the Independent Mapping Space Material Node Subsystem; 2501G is the Independent Mapping Space Medium Node Subsystem; 2501H is the Independent Mapping Space Texture Node Subsystem; 25011 is the Independent Mapping Space File Settings Node Subsystem; 2501X is the Independent Mapping Space Node Graph Subsystem; 2501Y is the Independent Mapping Space Node Pin Subsystem; and 2501Z is the Independent Mapping Space Node Attributes Subsystem.

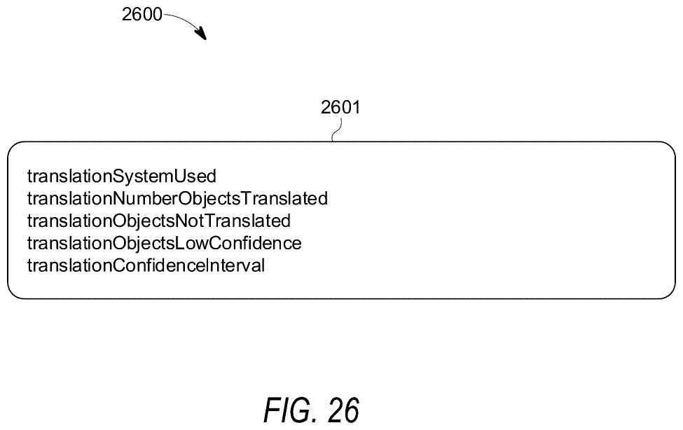

FIG. 26 depicts an example 2600 of a list of metadata labels that form a translation metadata subsystem 2601 for the disclosed framework of IMS metadata. For the subsystem 2601 the following metadata labels are included: translationSystemUsed, translationNumberObjectsTranslated, translationObjectsNotTranslated, translationObjectsLowConfidence, translationConfidenceInterval.

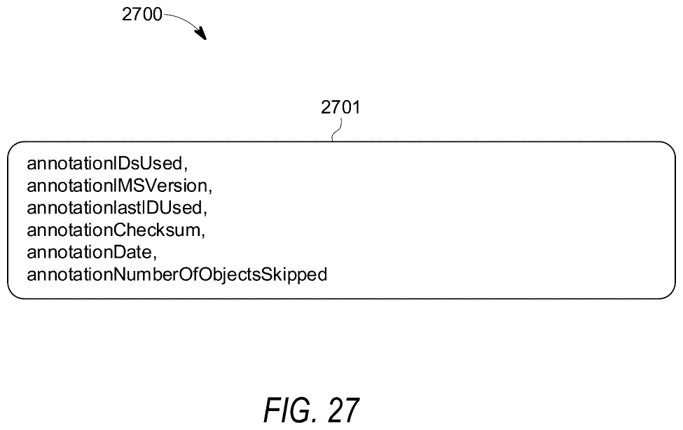

FIG. 27 depicts an example 2700 of a list of metadata labels that form an annotation subsystem 2701 for the disclosed framework of IMS metadata. For the subsystem 2701 the following metadata labels are included: annotationIDsUsed, annotationIMSVersion, annotationlastIDUsed, annotationChecksum, annotationDate, annotationNumberOfObjectsSkipped.

Accordingly, there is provided an IMS and ITMF that specifies the location of metadata information within the ITMF specifications and how to combine such ITMF metadata with IMS metadata to extend IMS metadata that are defined in this specification document for the purposes of annotating scene-based media or translating scene-based media from one representation to another. The ITMF Data Encoding Specification, which can be understood as according to embodiments herein, provides metadata that augment, but do not replace, metadata in the IMS. The ITMF Scene Graph Specification describes metadata and relationships between ITMF metadata in the context of an ITMF scene. The ITMF Container Specification describes how to package and encrypt scene assets and an ITMF scene graph into a single file, i.e., “container.” In cases where metadata from ITMF Data Encoding duplicates metadata from the IMS, the IMS metadata shall be used.

And on the use of ITMS and IMS to annotate scene media, there is IMS metadata, and the metadata in this document guides the use of the ITMF metadata that can be used to supplement the IMS. In some cases, there is no ITMF metadata to further describe IMS metadata. In such cases, the metadata that is used to annotate scene-based media is entirely specified in this document. The IMS is a superset of ITMF metadata. The difference between IMS and ITMF metadata is that the ITMF does not define metadata for certain features of scene-based media, for example, to describe the organization of an asset's binary data within a buffer of memory. In this case, the IMS provides metadata that can be used to describe the organization of a buffer without any reference to the ITMF specifications.

For all cases where ITMF metadata can be used to supplement IMS metadata, the description of the IMS metadata includes an ITMF node code point, i.e. a numeric value that can be used to locate the corresponding ITMF description for the node. Associated with the description of that node code point in the ITMF Data Encoding Specification, there may be a list of pins and attributes that can be used to extend the IMS metadata. Note: As with nodes defined in the ITMF Data Encoding Specification, pins and attributes that are also defined in the ITMF have their respective sets of code points. Pin and attribute code point values are not used in the IMS and are not referenced in this document according to one or more embodiments.

And as an example, the following of using the ITMF Data Encoding Specification to extend IMS metadata specified in this document. Both the IMS and ITMF can be used to create metadata for a specular material node, which has a node code point value of 18 as identified in the materials node subsystem in the IMS. An annotation application may wish to identify a particular node within scene-based media as a specular material node using its IMS label the label “ims.logical.material.specular” from the IMS. However, the ITMF Data Encoding Specification lists several pins that may be used to further describe the specular material node. Using the ITMF node code point 18 to identify the correct list of pins and attributes that may extend the IMS metadata from the ITMF Date Encoding Specification for the specular material node, Table 1 identifies the list of pins that serve as properties of a specular material node, i.e., to enable a renderer to create the specular material.

TABLE 1
ITMF pins for specular material node (18)

| | |
|---|---|
| reflection | smooth |
| transmission | smoothShadowTerminator |
| brdf | roundEdges |
| roughness | medium |
| anistropy | fake_shadows |
| rotation | refractionAlpha |
| spread | thin Wall |
| index | filmwidth |
| dispersion_coefficient_B | filmindex |
| bump | priority |
| normal | customAov |
| displacement | customAovChannel |
| opacity | layer |

Referring to ITMF Data Encoding specification and its complete list of pin names in alphabetical order, Table 2 provides the labels that are used as the metadata for the pins in Table 1. Note: For the purposes of this example, the pin labels are taken from table 294 in Version 2.0 of the ITMF Data Encoding Specification.

TABLE 2
Pins and pin names for specular material node (18)

| Pin | Pin name | IMS label |
|---|---|---|
| reflection | Reflection | ims.logical.material.specular.reflection |
| transmission | Transmission | ims.logical.material.specular.transmission |
| brdf | Brdf | ims.logical.material.specular.brdf |
| roughness | Roughness | ims.logical.material.specular.roughness |
| anistropy | Anistropy | ims.logical.material.specular.anistropy |
| rotation | Rotation | ims.logical.material.specular.rotation |
| spread | Spread | ims.logical.material.specular.spread |
| index | Index | ims.logical.material.specular.index |
| dispersion_coefficient_B | DispersionCoefficientB | ims.logical.material.specular.dispersionCoefficientB |
| bump | Bump | ims.logical.material.specular.bump |
| normal | Normal | ims.logical.material.specular.normal |
| displacement | Displacement | ims.logical.material.specular.displacement |
| opacity | Opacity | ims.logical.material.specular.opacity |
| smooth | Smooth | ims.logical.material.specular.smooth |
| smoothShadowTerminator | SmoothShadowTerminator | ims.logical.material.specular.smoothShadowTerminator |
| roundEdges | RoundEdges | ims.logical.material.specular.roundEdges |
| medium | Medium | ims.logical.material.specular.medium |
| fake_shadows | FakeShadows | ims.logical.material.specular.fakeShadows |
| refractionAlpha | RefractionAlpha | ims.logical.material.specular.refractionAlpha |
| thin Wall | Thin Wall | ims.logical.material.specular.thinWall |
| filmwidth | Film Width | ims.logical.material.specular.filmWidth |
| filmindex | FilmIndex | ims.logical.material.specular.filmIndex |
| priority | Priority | ims.logical.material.specular.priority |
| customAov | CustomAov | ims.logical.material.specular.customAoV |
| customAovChannel | CustomAovChannel | ims.logical.material.specular.customAovChannel |
| layer | Layer | ims.logical.material.specular.layer |

Referring to ITMF Data Encoding specification and its complete list of pin names in alphabetical order, Table 2 provides the labels that are used as the metadata for the pins in Table 1. Note: For the purposes of this example, the pin labels are taken from table 294 in Version 2.0 of the ITMF Data Encoding Specification. Although the labels shown in Table 2 illustrate different use of case formats, an annotation or translation process shall not be sensitive to case when processing IMS labels according to exemplary embodiments. To create an IMS label that is augmented with metadata from the ITMF Data Encoding Specification, the pin or attribute name from the ITMF Data Encoding Specification shall be appended using dot notation to the IMS label corresponding to the node's IMS label as specified within this document.

A.2 Generalized annotation process for scene media with IMS metadata: An IMS-annotated scene or media asset is derived by the following steps. 1. If the specification that defines the format of the scene or asset, e.g. the openUSD specification for USD assets, provides a mechanism to store annotation metadata, that mechanism should be used to record IMS metadata into the asset or scene. Otherwise, the IMS metadata should be stored into the scene or media asset via any commenting or metadata annotation mechanism supported by the format unless this document specifies a specific annotation process to be used for the format, e.g. glTF. 2. IMS labels are stored into the media file either in the form of comments or according to the mechanism supported by the media format. Note: the proximity of the label to the media content that it describes within the file should be such that upon visual inspection of the annotation, it is obvious that the label describes the portion of the file to which it is closely located. 3. Starting with the value of zero or with the value portion of the “ims.process.annotation.next.id” keyword in an existing IMS header, each IMS label that is recorded into the media file is assigned a unique unsigned integer value in ascending order. Each integer value shall be recorded consecutive to each IMS label as the value portion of a keyword and value pair, in which the keyword is “mpeg-id”. There shall be no instances of duplicate identifier integer values in the asset file. 4. An IMS annotation header that conforms to the data model specified in Clause A.3 shall be created and stored at the beginning of the file for the scene or media asset, but only if no such header already exists in the media file. The value portion of ims.process.annotation.hash keyword shall be set to “#######32-character-hash########” as shown in Table A.3 when initially creating the header in the media file; otherwise, the existing value is not changed until the end of the annotation process. 5. The next integer ID value that should be used in the consecutive numbering process of storing annotation labels into the media file shall be stored as the value portion of the “ims.process.annotation.next.id” keyword of the annotation header. 6. After all IMS labels, along with their integer values are stored into the file, a 32-character (128 bit value represented as a 32-character ASCII string) MD5 value string shall be created for the media file containing the annotated scene or media asset. 7. The MD5 value string shall replace any existing value portion for the “ims.process.annotation.hash” keyword within the annotation header.

An IMS annotation header shall include the IMS label keyword and value pairs for an initial annotation of the scene media, IMS label and initial values for annotation header:
ims.process.annotation.hash:#######32-character-hash########
ims.process.annotation.ims.version:1.0
ims.process.annotation.next.id:0

There is also provided a fixity checking for scene media that is already annotated with IMS metadata according to exemplary embodiments: (i) Copy and save the MD5 value from the annotation header of the scene media file. Reset the MD5 value to “#######32-character-hash########”. The scene media file should be restored to its exact contents prior to step 7 above (The MD5 value string shall . . . ). (ii) Regenerate the MD5 using the annotated scene file with the MD5 value now reset to “#######32-character-hash########” in its header. (iii) Compare the regenerated MD5 to the MD5 value that was previously stored in the header.

If the regenerated MD5 does not match the MD5 value that was copied from the scene media file, then the annotation metadata within the scene media file should not be regarded as consistent with the media in the file. Otherwise, the annotation metadata within the scene media file can be regarded as consistent with the media in the file.

There is also provided a generalized update of scene media that is already annotated with IMS metadata: (i) Update the media i.e. insert, remove, or change the media in the media file.

If any updates to the media result in the removal of existing IMS metadata, then a process to remove all existing IMS metadata should be followed: (i) Regenerate the IMS metadata following the annotation process specified in this document for the media format or the generalized annotation process specified in A.2, if no such annotation process is specified for the media format.

If the update to the scene media is to insert additional media into the media file, then the following generalized process is executed: (i) Starting with the integer value for the “ims.process.annotation.next.id” keyword in the IMS annotation header, annotate the newly inserted media using the next integer value as a starting value “mpeg-id” keywords for each IMS label added. (ii) Update the value for the ims.process.annotation.next.id keyword and value pair in the annotation header after the media has been annotated. (iii) Regenerate the MD5 hash and store the new MD5 value as specified in steps six and seven above.

There is also provided for mapping of glTF 2.0 properties to IMS according to exemplary embodiments and a mapping of the IMS to glTF 2.0 properties. Note: Some glTF 2.0 properties carry application specific or authorship information, and as such, are not mapped to IMS values. As a Mechanism to store IMS metadata within glTF 2.0 files The KHR_xmp_jsonld shall be used to annotate glTF media. And as a mapping of IMS metadata to glTF 2.0 (base specification), glTF properties from the base specification are mapped to the IMS as shown in Table 3:

TABLE 3
glTF 2.0 properties to IMS

| glTF 2.0 property | IMS identifiers |
|---|---|
| Accessor | {ims.physical.local.specification} |
| Accessor Sparse | {ims.physical.local.specification, |
| | ims.physical.local.indexType} |
| Accessor Sparse Indices | {ims.physical.local.specification, |
| | ims.physical.local.indexType, |
| | ims.physical.stream.streamIndices} |
| Accessor Sparse Values | {ims.physical.local.specification, |
| | ims.physical.local.indexType, |
| | ims.physical.stream.streamData} |
| Animation | {ims.process.animation} |
| Animation Channel | {ims.process.animation.property, |
| | ims.process.animation.interpolation, |
| | ims.process.animation.outputPattern} |
| Animation Channel Target | {ims.process.animation.property, |
| | ims.process.animation.interpolation, |
| | ims.process.animation.outputPattern, |
| | ims.process.animation.target} |
| Animation Sampler | {ims.process.animation.interpolation, |
| | ims.process.animation.outputPattern} |
| Asset | {ims.physical.graph.geometry Archive} |
| Buffer | {ims.physical.stream.genericBlob} |
| Buffer View | {ims.physical.stream.genericBlob, |
| | ims.physical.local.specification } |
| Camera | {ims.process.camera} |
| Camera Orthographic | {ims.process.camera.universal.orthographic} |
| Camera Perspective | {ims.process.camera.thinlens} |
| glTF | graph.sceneGraph |
| Image | texture.image |
| Material | material |
| Material Normal Texture Info | material |
| Material Occlusion Texture Info | texture.raySwitch |
| Material PBR Metallic Roughness | material.universal |
| Mesh | geometry.mesh |
| Mesh Primitive | geometry.geometricPrimitive |
| Node | transformation |
| Sampler | texture.sampler |
| Scene | graph.sceneGraph |
| Skin | texture |
| Texture | texture.image; texture.sampler |
| Texture Info | texture.index |

And as for annotation processes for glTF according to exemplary embodiments, there is provided the following. The namespace is mpeg.ims.2025 and an RDF schema for IMS is provided. There is an annotation process for glTF file not previously annotated according to exemplary embodiments herein which provide an ordered sequence of steps to annotate a glTF file, i.e. a file with a filetype or suffix of “gltf,” that has not been previously annotated with IMS metadata. Each sequence is defined using a table with line numbers in the left column of the table. Each line number refers to a specific JSON stanza for the KHR_xmp_json_ld extension to be used to annotate the glTF file or a descriptive statement in an italicized font that describes other JSON statements that can or should appear in the annotation process. Such JSON statements that are described in an italicized font are specified in other portions herein.

And extensionsUsed property of glTF file are provided according to embodiments herein that specify the first in the ordered sequence of steps to annotate a glTF file that has not previously been annotated with the IMS. The “extensionsUsed” property shall be present in the asset object of the glTF file. If not present in the list of extensionsUsed for the “extensionsUsed” property, the “KHR_xmp_json_ld” extension shall be added to the list of extensionsUsed. Lines three through five (inclusive) in Table 4 illustrate an example of the “KHR_xmp_json_ld” extension added to the “extensionsUsed” property for an asset.

TABLE 4
KHR_xmp_json_ld in extensionsUsed

| Line | Syntax description |
|---|---|
| 1 | “asset” : { |
| 2 | }, |
| 3 | “extensionsUsed” : [ |
| 4 | “KHR_xmp_json_ld” |
| 5 | ] |

Line three in Table 4 illustrates an array of extensions that are used within the “asset” object of the glTF file. In this illustration, the array is comprised of only one element, i.e., the “KHR_xmp_json_ld” extension identified on line four. Line five closes the array defined on line three. There is also provided herein extension properties for KHR_xmp_json_ld which specifies the second in the ordered sequence of steps to annotate a glTF file that has not previously been annotated with the IMS. If not already present for the “asset” object, the “extensions” property shall be added to the “asset” object as shown in Table 5.

TABLE 5
extensions property for KHR_xmp_json_ld

| Line | Syntax description |
|---|---|
| 1 | “extensions” : { |
| 2 | “KHR_xmp_json_ld” : { |
| 3 | An array of packets as defined in other tables herein |
| 4 | } |
| 5 | } |

Line three in Table 5 provides a description of the specification in Table 5 that is specified in other tables herein, which may be considered subclauses. IMS annotation header packet for KHR_xmp_json_ld specifies creation of an IMS annotation header as the third in the ordered sequence of steps to annotate a glTF file that has not previously been annotated with the IMS. An IMS annotation header packet, as defined in Table 6, shall be placed in the glTF “asset” object as the first packet, i.e. at index 0, in the array of packets within the KHR_xmp_json_ld extension.

TABLE 6
IMS annotation header packet for KHR_xmp_json_ld

| Line | Syntax description |
|---|---|
| 1 | “extensions” : { |
| 2 | “KHR_xmp_json_ld” : { |
| 3 | “packets” : [ |
| 4 | { |
| 5 | “@context” : { |
| 6 | “mpeg” : “https://www.mpeg.org/meetings/mpeg-121/” |
| 7 | }, |
| 8 | “@id” : “” |
| 9 | “mpeg:ims.process.annotation.hash”:“#######32-character-hash########”. |
| 10 | “mpeg:ims.process.annotation.ims.version”:“1.0”, |
| 11 | “mpeg:ims.process.annotation.next.id”:0 |
| 12 | }, |
| 13 | Additional packets corresponding to annotation of top level objects in the glTF. |
| 14 | ] |
| 15 | } |
| 16 | } |

Line 13 of Table 6 describes the presence of additional packets within the array of packets, where each additional packet corresponds to the annotation of other objects within the glTF. The specification of these additional packets is provided in other portions herein.

There is also provided herein instantiation of IMS annotation header packet by glTF asset object which specifies the fourth in the ordered sequence of steps to annotate a glTF file that has not previously been annotated with the IMS.

The IMS annotation header packet shall be referenced from, i.e. instantiated by, the “extensions” property in the high level asset object of the glTF as defined in Table 7.

TABLE 7
instantiation of IMS header packet 0

| Line | Syntax description |
|---|---|
| 1 | “asset” : { |
| 2 | “extensions” : { |
| 3 | “KHR_xmp_json_ld” : { |
| 4 | “packet” : 0 |
| 5 | } |
| 6 | } |
| 7 | } |

There is also provided KHR_xmp_json_ld packets mapping to top level objects which specifies the fifth in the ordered sequence of steps to annotate a glTF file that has not previously been annotated with the IMS. In this step, the result is the extension of the array of packets, i.e. in which the IMS header packet is located at index 0 of the array, as specified in Table 6. For this step, one or more packets is added to the array in which each packet defines a mapping of an IMS label to an individual top level object within the glTF. In this step, the descriptive comment on line 13 of Table 6 is addressed and completed. Note: Top level objects that may be annotated by KHR_xmp_json_ld include: asset, scene, node, mesh, image, material, and animation objects. Each packet shall be defined using the format of top level object packets as specified in Table 8

TABLE 8
format of top level object packets

| Line | Syntax description |
|---|---|
| 1 | “@context” : { |
| 2 | “mpeg” : “https://www.mpeg.org/meetings/mpeg-121/” |
| 3 | }, |
| 4 | “@id” : “” |
| 5 | “mpeg:ims label” : { |
| 6 | “mpeg:mpeg-id” : unique unsigned integer value, |
| 7 | “mpeg:mpeg-value” : path reference to glTF object or glTF object property |
| 8 | }, no comma for the last packet |

And italicized portions of the format are determined as part of the annotation process of the glTF as follows: ims label is any of the IMS labels following the process specified in Annex A and the keyword mapping in Annex B; unique integer value is equal to or greater than the value portion of “mpeg: ims.process.annotation.next.id” in the IMS annotation header packet as shown in Table 6 and is not a duplicate of any existing integer values used for other mpeg: mpeg-id stanzas in the glTF, and; path reference to glTF object or glTF object property is the unique path within the glTF for the object or object property that is described by the IMS label.

The last packet in the array shall not have a comma after its closing brace as indicated by the descriptive comment in line 8 of Table 8. All other packets shall have the comma following the closing brace corresponding to its packet, i.e., to indicate the presence of a subsequent packet. There is also provided herein instantiation of KHR_xmp_json_ld packet metadata by top level objects which specifies the sixth in the ordered sequence of steps to annotate a glTF file that has not previously been annotated with the IMS.

For each packet defined with respect to instantiation of KHR_xmp_json_ld packet metadata by top level objects, the individual top level object at the path location referenced in the packet shall be extended, via its “extensions” property, to include the index value or index values, corresponding to the packet(s) that describe the glTF object or its properties. Table 9 specifies the syntax to complete this step.

TABLE 9
instantiation of single IMS object packet for object

| Line | Syntax description |
|---|---|
| 1 | top level object: { |
| 2 | “extensions” : { |
| 3 | “KHR_xmp_json_ld” : { |
| 4 | “packet” : index of packet in array of packets specified in table 8 |
| 5 | } |
| 6 | } |
| 7 | } |

If there is more than one packet in the KHR_xmp_json_ld packet array that describes the object, then lines three, four, and five are repeated with a comma following the closing curly brace for each packet that is not the last packet. Table 10 provides an example of a single top level object that instantiates three packets.

TABLE 10
instantiation of multiple IMS metadata packets for object

| Line | Syntax description |
|---|---|
| 1 | top level object: { |
| 2 | “extensions” : { |
| 3 | “KHR_xmp_json_ld” : { |
| 4 | “packet” : index of a first packet in array of packets specified in table 8 |
| 5 | },comma is used as separator |
| 6 | “KHR_xmp_json_ld” : { |
| 7 | “packet” : index of a second packet in array of packets specified in table 8 |
| 8 | }, comma is used as separator |
| 9 | “KHR_xmp_json_ld” : { |
| 10 | “packet” : index of a third packet in array of packets specified in table 8 |
| 11 | } no comma for the last packet instantiation |
| 12 | } |
| 13 | } |

There is also provided herein an end of annotation process which specifies the last and seventh step in the ordered sequence of steps to annotate a glTF file that has not previously been annotated with the IMS. Note: It may be important that each of the other steps, i.e. one through six as specified above respectively, are fully complete before this last step is performed according to embodiments. Upon the instantiation of each of the packets in the KHR_xmp_json_ld packet array, the header packet (packet 0 in the packet array) shall be updated by applying the process specified herein according to a process to store annotation values in header packet which specifies a process comprised of an ordered sequence of steps process to be applied to the header packet shown in Table 6: replace the value of zero as shown at line 11 in Table 6 with the integer value of the next identifier to be used in a subsequent annotation process for the same glTF file; create a 32-character MD5 value for the annotated glTF file; replace the value of “#######32-character-hash########” as shown at line nine in Table 6 with the 32-character MD5 value.

There is also provided herein adding IMS metadata to a previously annotated glTF file which defines an ordered sequence of steps to add IMS metadata to a glTF file, i.e. a file with a filetype or suffix of “gltf,” that has previously been annotated with IMS metadata.

There is also provided herein packets for objects to be annotated which specifies the first in an ordered sequence of steps to add IMS metadata to a glTF file that has previously been annotated with IMS metadata. In this step, the result is the extension of the array of packets, i.e. in which the IMS header packet is located at index 0 of the array, as specified in Table 6. For this step, one or more packets is added to the array in which each additional packet defines a mapping of an IMS label to an individual top level object within the glTF. Note: Top level objects that may be annotated by KHR_xmp_json_ld include: asset, scene, node, mesh, image, material, and animation objects.

Each packet shall be defined using the format of top level object packets as specified in Table 8 where italicized portions of the format are determined as part of the annotation process of the glTF as follows: ims label is any of the IMS labels following the process specified with respect to annotation using IMS and ITMF above and the keyword mapping of IMS to glTF 2.0 above; unique integer value is equal to or greater than the value portion of “mpeg: ims.process.annotation.next.id” in the IMS annotation header packet as shown in Table C.3 and is not a duplicate of any existing integer values used for other mpeg: mpeg-id stanzas in the glTF, and; path reference to glTF object or glTF object property is the unique path within the glTF for the object or object property that is described by the IMS label.

The last packet in the array shall not have a comma after its closing brace as indicated by the descriptive comment in line 8 of Table 8. All other packets shall have the comma following the closing brace corresponding to its packet, i.e., to indicate the presence of a subsequent packet. There is also provided herein to Instantiate metadata with newly added IMS metadata which specifies the second in an ordered sequence of steps to add IMS metadata to a glTF file that has previously been annotated with IMS metadata.

For each packet added with respect to such Define packets for objects to be annotated above, the individual top level object at the path location referenced in the packet shall be extended, via its “extensions” property, to include the index value or index values, corresponding to the packet(s) that were added by the process specified with respect to such Define packets for objects to be annotated above. Table 9 illustrates the instantiation of a single metadata packet for a top level object. Table 10 illustrates the instantiation of multiple metadata packets for a top level object. There is also provided herein an end of annotation process to add metadata to a previously annotated glTF file which specifies the last and third step in the ordered sequence of steps to annotate a glTF file that has previously been annotated with IMS metadata. Note: It is important that both of the other steps, i.e. one through two as specified in subclauses (or tables herein) define packets for objects to be annotated through Instantiate metadata with newly added IMS metadata respectively, are fully complete before this last step is performed.

Upon the instantiation of each of the packets in the KHR_xmp_json_ld packet array, the header packet (packet 0 in the packet array) shall be updated according to a process to store annotation values in header packet which specifies a process comprised of an ordered sequence of steps process to be applied to the header packet shown in Table 6: replace the existing integer value as shown at line 11 in Table 6 with the integer value of the next identifier to be used in a subsequent annotation process for the same glTF file; create a 32-character MD5 value for the updated glTF file; replace the value existing value for the label “mpeg: ims.process.annotation.hash” as shown at line nine in Table 6 with the 32-character MD5 value created in this subclause. There is also provided herein Removing IMS metadata from a previously annotated glTF file which defines an ordered sequence of steps to remove IMS metadata from a glTF file, i.e. a file with a filetype or suffix of “gltf,” that has previously been annotated with IMS metadata.

There is also provided herein Remove packets and their corresponding instantiations of which the steps are executed as ordered: identify the packets in the packets array, i.e. those defined and added in line 13 in Table 6 according to define KHR_xmp_json_ld packets mapping to top level objects or Define packets for objects to be annotated, corresponding to the metadata to be removed; at the object corresponding to the path, i.e. at line seven in Table 8, in the definition of the identified packet, remove the corresponding instantiation of the metadata from the object's “extensions” array; remove the identified packet from the packets array.

There is also provided herein to Update MD5 value in header packet of which following steps are executed as ordered: create a 32-character MD5 value for the updated glTF file; replace the existing value for the label “mpeg: ims.process.annotation.hash” as shown at line nine in Table 4 with the 32-character MD5 value created in this subclause.

As such, there is provided a method including: creating a metadata framework to facilitate the preservation of information stored in a scene graph during scene graph translation from one scene graph format to another scene graph format; such framework comprised of organizing the metadata into subsystems of metadata; each subsystem further corresponding to collections of information common across a plurality of scene graph formats; each subsystem further comprised of labels to more precisely characterize the information for each system; one such subsystem containing information related to a process that translates one instance of one scene graph format into a second instance of a potentially second instance of the same or a second scene graph format.

And there is provided a method including: creating a metadata framework to facilitate the preservation of information stored in a scene graph during scene graph translation from one scene graph format to another scene graph format; such framework comprised of organizing the metadata into subsystems of metadata; each subsystem further corresponding to collections of information common across a plurality of scene graph formats; each subsystem further comprised of labels to more precisely characterize the information for each system; one such subsystem containing information related to a process that identifies the specific metadata for a portion of a particular instance of a scene graph format.

And accordingly, there is provided a method of streaming immersive media, executable by a processor, the method including: ingesting content of a scene of the immersive media, the content including a scene graph that is of the scene and is in a first scene graph format; determining whether to translate the scene graph from the first scene graph format to a second scene graph format; translating the scene graph from the first scene graph format to the second scene graph format according to a metadata framework including at least a first system of metadata and a second system of metadata, the first system of metadata including a plurality of first metadata representing first information shared commonly across the first scene graph format and the second scene graph format, and the second system of metadata including a plurality of second metadata representing second information shared commonly across the first scene graph format and the second scene graph format; and streaming the content of the immersive media based on the second scene graph translated from the first scene graph according to the metadata framework.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of streaming immersive media, executable by a processor, the method comprising:
ingesting media content of the immersive media and comprising Independent Mapping Space (IMS) metadata of a scene of the media content;
extending the IMS metadata by annotating the IMS metadata with Immersive Technologies Media Format (ITMF) metadata representing at least an ITMF node code point; and
streaming the media content of the immersive media based on extending the IMS metadata annotated with the ITMF metadata.

2. The method according to claim 1, wherein annotating the IMS metadata with the ITMF metadata comprises identifying a node within the scene-based media depending on an IMS label “ims.logical.material.specular”.

3. The method according to claim 2, wherein the ITMF metadata further represents a list of pins and attributes comprising pin and attribute code point values.

4. The method according to claim 1, wherein extending the IMS metadata further comprises:
determining whether a format of any of the scene and an asset of the scene indicates a mechanism to store annotation metadata; and
annotating the IMS metadata based on whether the mechanism is indicated by any of the scene and the assert of the scene and by storing IMS labels to a media file.

5. The method according to claim 4, wherein extending the IMS metadata further comprises:
obtaining a value of an “ims.process.annotation.next.id” keyword of an IMS header; and
assigning an unsigned integer values to IMS labels stored in a media file as a value portion of a keyword and a value pair in which the keyword is “mpeg-id”; and
storing an annotation header to the media file based on determining that the media file lacks an annotation header;
storing annotation labels to the media file as a value portion of the “ims.process.annotation.next.id” keyword of the IMS header;
creating a 32-character value string, as a 128 bit value represented as a 32-character ASCII string, of the media file, and the media files contains any of an annotated scene and a media asset of the content of the scene; and
replacing a value portion of an “ims.process.annotation.hash” keyword within the annotation header with the 32-character value string.

6. The method according to claim 5, wherein the annotation header comprises an IMS label keyword and value pairs, for an initial annotation of scene media of the scene, according to the following format:
ims.process.annotation.hash:#######32-character-hash########
ims.process.annotation.ims.version:1.0
ims.process.annotation.next.id:0.

7. The method according to claim 6, wherein annotating the scene graph comprises at least one of:
checking for an already IMS metadata annotated version of the media content, and
providing an update to the already IMS metadata annotated version of the media content.

8. A device for streaming immersive media, the device comprising:
at least one memory configured to store program code; and
at least one processor configured to read the program code and operate as instructed by the program code to:
ingest media content of the immersive media and comprising Independent Mapping Space (IMS) metadata of a scene of the media content;
extend the IMS metadata by annotating the IMS metadata with Immersive Technologies Media Format (ITMF) metadata representing at least an ITMF node code point; and
stream the media content of the immersive media based on extending the IMS metadata annotated with the ITMF metadata.

9. The device according to claim 8, wherein annotating the IMS metadata with the ITMF metadata comprises identifying a node within the scene-based media depending on an IMS label “ims.logical.material.specular”.

10. The device according to claim 9, wherein the ITMF metadata further represents and a list of pins and attributes comprising pin and attribute code point values.

11. The device according to claim 8, wherein extending the IMS metadata further comprises:
determining whether a format of any of the scene and an asset of the scene indicates a mechanism to store annotation metadata; and
annotating the IMS metadata based on whether the mechanism is indicated by any of the scene and the assert of the scene and by storing IMS labels to a media file.

12. The device according to claim 11, wherein extending the IMS metadata further comprises:
obtaining a value of an “ims.process.annotation.next.id” keyword of an IMS header;
assigning an unsigned integer values to IMS labels stored in a media file as a value portion of a keyword and a value pair in which the keyword is “mpeg-id”;
storing an annotation header to the media file based on determining that the media file lacks an annotation header;
storing annotation labels to the media file as a value portion of the “ims.process.annotation.next.id” keyword of the IMS header;
creating a 32-character value string, as a 128 bit value represented as a 32-character ASCII string, of the media file, and the media files contains any of an annotated scene and a media asset of the content of the scene; and
replacing a value portion of an “ims.process.annotation.hash” keyword within the annotation header with the 32-character value string.

13. The device according to claim 12, wherein the annotation header comprises an IMS label keyword and value pairs, for an initial annotation of scene media of the scene, according to the following format:
ims.process.annotation.hash:#######32-character-hash########
ims.process.annotation.ims.version:1.0
ims.process.annotation.next.id:0.

14. The device according to claim 13, wherein annotating the scene graph comprises at least one of:
checking for already IMS metadata annotated version of the media content; and
providing an update to the already IMS metadata annotated version of the media content.

15. A non-transitory computer-readable medium storing instructions, the instructions comprising: one or more instructions that, when executed by at least one processor of a device for streaming immersive media, cause the at least one processor to:
ingest media content of the immersive media and comprising Independent Mapping Space (IMS) metadata of a scene of the media content;
extend the IMS metadata by annotating the IMS metadata with Immersive Technologies Media Format (ITMF) metadata representing at least an ITMF node code point; and
stream the media content of the immersive media based on extending the IMS metadata annotated with the ITMF metadata.

16. The non-transitory computer-readable medium according to claim 15, wherein
annotating the IMS metadata with the ITMF metadata comprises identifying a node within the scene-based media depending on an IMS label “ims.logical.material.specular”, and
the ITMF metadata further represents and a list of pins and attributes comprising pin and attribute code point values.

17. The non-transitory computer-readable medium according to claim 15, wherein extending the IMS metadata further comprises:
determining whether a format of any of the scene and an asset of the scene indicates a mechanism to store annotation metadata; and
annotating the IMS metadata based on whether the mechanism is indicated by any of the scene and the assert of the scene and by storing IMS labels to a media file.

18. The non-transitory computer-readable medium according to claim 17, wherein extending the IMS metadata further comprises:
obtaining a value of an “ims.process.annotation.next.id” keyword of an IMS header;
assigning an unsigned integer values to IMS labels stored in a media file as a value portion of a keyword and a value pair in which the keyword is “mpeg-id”;
storing an annotation header to the media file based on determining that the media file lacks an annotation header;
storing annotation labels to the media file as a value portion of the “ims.process.annotation.next.id” keyword of the IMS header;
creating a 32-character value string, as a 128 bit value represented as a 32-character ASCII string, of the media file, and the media files contains any of an annotated scene and a media asset of the content of the scene; and
replacing a value portion of an “ims.process.annotation.hash” keyword within the annotation header with the 32-character value string.

19. The non-transitory computer-readable medium according to claim 18, wherein the annotation header comprises an IMS label keyword and value pairs, for an initial annotation of scene media of the scene, according to the following format:
ims.process.annotation.hash:#######32-character-hash########
ims.process.annotation.ims.version:1.0
ims.process.annotation.next.id:0.

20. The non-transitory computer-readable medium according to claim 19, wherein annotating the scene graph comprises at least one of:
checking for already IMS metadata annotated version of the media content; and
providing an update to the already IMS metadata annotated version of the media content.
